SEQUENCE LISTING (25 sequences)

SEQ ID NO: 1 - DNA, 39 bp, Artificial sequence
  Candidate sequence used in nucleotide library for aptamers
acacgcgcatgcnnnnnnnnnnnnnnngcatgcgccaca

SEQ ID NO: 2 - DNA, 33 bp, Artificial sequence
  Adapter sequence used in library construction
acactctttccctacacgacgctcttccgatct

SEQ ID NO: 3 - DNA, 45 bp, Artificial sequence
  Complement to an adapter sequence used in library construction
gcatgcgcgtgtagatcggaagagcgtcgtgtagggaaagagtgt

SEQ ID NO: 4 - DNA, 33 bp, Artificial sequence
  Adapter sequence used in library construction
gatcggaagagctcgtatgccgtcttctgcttg

SEQ ID NO: 5 - DNA, 45 bp, Artificial sequence
  Complement to an adapter sequence used in library construction
caagcagaagacggcatacgagctcttccgatctgtggcgcatgc

SEQ ID NO: 6 - DNA, 58 bp, Artificial sequence
  PCR primer
aatgatacggcgaccaccgagatctacactctttccctacacgacgctcttccgatct

SEQ ID NO: 7 - DNA, 34 bp, Artificial sequence
  PCR primer
caagcagaagacggcatacgagctcttccgatct

SEQ ID NO: 8 - DNA, 33 bp, Artificial sequence; identical to SEQ ID NO: 2
  PCR sequencing primer

SEQ ID NO: 9 - DNA, 20 bp, Artificial sequence
  Control sequence for library
ggacuagcgguggcuagucc

SEQ ID NO: 10 - DNA, 20 bp, Artificial sequence
  Control sequence for library
ggacuagcgauagcuagucc

SEQ ID NO: 11 - DNA, 15 bp, Artificial sequence
  candidate aptamer sequence against a-thrombin
ggttggtgtggttgg

SEQ ID NO: 12 - DNA, 15 bp, Artificial sequence
  candidate aptamer sequence against a-thrombin
ggttggtgtggtttg

SEQ ID NO: 13 - DNA, 15 bp, Artificial sequence
  candidate aptamer sequence against a-thrombin
ggttggtttggttgg

SEQ ID NO: 14 - DNA, 15 bp, Artificial sequence
  candidate aptamer sequence against a-thrombin
ggttggtgcggttgg

SEQ ID NO: 15 - DNA, 15 bp, Artificial sequence
  candidate aptamer sequence against a-thrombin
agtgtggtcggaagt

SEQ ID NO: 16 - DNA, 15 bp, Artificial sequence
  candidate aptamer sequence against a-thrombin
atgtggcgaggatga

SEQ ID NO: 17 - DNA, 15 bp, Artificial sequence
  candidate aptamer sequence against a-thrombin
tatgtgggtgaatgc

SEQ ID NO: 18 - DNA, 15 bp, Artificial sequence
  candidate aptamer sequence against a-thrombin
gttggtggcggaagg

SEQ ID NO: 19 - DNA, 15 bp, Artificial sequence
  candidate aptamer sequence against a-thrombin
gctatcatcgcaacg

SEQ ID NO: 20 - DNA, 15 bp, Artificial sequence
  candidate aptamer sequence against a-thrombin
gctatcatcgcaccg

SEQ ID NO: 21 - DNA, 15 bp, Artificial sequence
  candidate aptamer sequence against a-thrombin
gctctcatcgcaacg

SEQ ID NO: 22 - DNA, 15 bp, Artificial sequence
  candidate aptamer sequence against a-thrombin
gctatcatctcaacg

SEQ ID NO: 23 - DNA, 15 bp, Artificial sequence
  A canonical thrombin binding aptamer sequence
ggttggtgtggttgg

SEQ ID NO: 24 - DNA, 35 bp, Artificial sequence
  A PDGF-binding aptamer
caggctacggcacgtagagcatcaccatgatcctg

SEQ ID NO: 25 - DNA, 49 bp, Artificial sequence
  Template for a hairpin loop structured aptamer
acacgcgcatgcnnnnnnnnnnnnnnnnnnnnnnnnngcatgcgccaca

(19) United States
(12) Patent Application Publication
(10) Pub. No.: US 2011/0263459 A1
(43) Pub. Date: Oct. 27, 2011

(54) DIRECT SELECTION OF STRUCTURALLY DEFINED APTAMERS

(76) Inventors: Philip N. Borer, Syracuse, NY (US); Mark P. McPike, Syracuse, NY (US)

(21) Appl. No.: 12/922,173

(22) PCT Filed: Mar. 12, 2009
(86) PCT No.: PCT/US09/37022

§ 371 Date: Jan. 3, 2011

Related U.S. Application Data
(62) Division of application No. 61/035,844, filed on Mar. 12, 2008.
Application No. 61/035,844 is a division of application No. 61/119,777, filed on Dec. 4, 2008.

(51) Int. Cl. C40B 40/06

(52) U.S. Cl. 506/16

(57) ABSTRACT

The present invention provides aptamer libraries with pre-defined secondary structures that can be used for oversampled screening for affinity binding. In one embodiment, a multiplex approach is employed to divide the library into degenerate subsets that are immobilized on multiple locations of a solid support such as a microarray chip

### CROSS-REFERENCE TO RELATED APPLICATIONS

This application claims priority to and the benefit of U.S. provisional patent applications Ser. Nos. 61/035,844 filed on Mar. 12, 2008, and 61/119,777, filed on Dec. 4, 2008, the entire contents of which applications are incorporated herein by reference.

### STATEMENT RE FEDERALLY SPONSORED RESEARCH

This invention described herein was sponsored by the NIH under Phase I SBIR grants awarded to Orthosystems, Inc., the U.S. government may have certain rights in this invention.

### FIELD OF THE INVENTION

The invention relates to the field of aptamers and their use.

### BACKGROUND OF THE INVENTION

Aptamers are nucleic acids or peptide molecules that bind targets with an affinity and specificity that rival antibody-antigen interactions. DNA/RNA aptamers promise to provide a cost-effective alternative to antibodies because there is no need for selection in animals or cell lines, they have shelf-lives of years, and they can be easily modified to reduce cross-reactivity with undesired targets. This ability to bind, and in some instances, alter their targets' functions have earned aptamers potential applications in biosensor development, affinity chromatography and recently therapeutics and diagnostics.

Traditionally, artificial aptamer sequences are discovered by SELEX (Systematic Evolution of Ligands by EXponential Enrichment) and other closely related methods of in vitro evolution. Starting libraries have relatively long oligomers of DNA/RNA sequences (80-120 nt) with central randomized regions (30-120 nt). These are sparsely sampled libraries with a probability of ˜10⁻⁴ that any particular sequence occurs in a typical starting pool for a randomized 30 mer, and of ˜10⁻²⁹ with randomized 70 mers. This means that such SELEX experiments begin with single copies of those sequences that are present by random chance. Evolution occurs via the selective pressure of binding to the target followed by amplification of the survivors; selection and amplification are repeated in typically 5-20 rounds. Winners are found by cloning and sequencing, after which a minimal core binding sequence is sought by truncating segments of the parent aptamer that are not needed for the interaction with the target.

Despite the wide adoption of the SELEX procedure for the discovery of DNA/RNA aptamers, only a few hundred target-specific aptamers have been discovered to date using this method compared with the discovery of thousands of antibodies during the same period. This limited success may stem primarily from a significant number of drawbacks with the SELEX selection method itself. First, the universe of possible sequences in SELEX experiments (e.g., 1×10¹⁸ for a 30 nucleotide random stretch), is so large that direct synthesis and screening of all sequences is impossible, even given the high-throughput advancements made in DNA/RNA synthesizer instrumentation. Second, even when SELEX identifies nucleic acid sequences with extremely high affinity for the target, these sequences are generally relatively long (typically 80-150 monomer units in length), and often have complex internal structures (secondary structures). Such long folded molecules are often disadvantageous for a variety of applications, where cost and ease of production and manipulation are better for short (20-40 unit), defined binding domains. Third, the SELEX methodology of repeated rounds of selection and amplification are cumbersome, time-consuming and expensive.

For the forgoing reasons, there is an unmet need for improved high-throughput methods of aptamer discovery.

### SUMMARY OF THE INVENTION

A procedure called, high throughput screening of aptamers (HTSA), is described for the rapid discovery of relatively small, structurally-defined nucleic acid sequences that bind targets with high affinity and selectivity.

In one aspect, the invention provides an aptamer library comprising a plurality of aptamer candidates. Each aptamer candidate is substantially of the same length and has a primary structure and a pre-selected secondary structure. The primary structure comprises at least a variable nucleotide sequence where nucleotides at m number of positions are varied, and a secondary structure comprising at least a single-stranded region and a double-stranded region, where the variable sequence is at least part of the single-stranded region, and where, for every 100 pmol of aptamer candidates, an average of at least about three copies of each possible variable sequence is represented.

In various embodiments, the pre-selected secondary structure is a hairpin loop, a bulge loop, an internal loop, a multi-branch loop, a pseudoknot or combinations thereof.

The variable sequence can have randomized nucleotides at some positions and invariant nucleotides at other positions, or randomized nucleotides at all positions. The variable sequence can be completely within the single-stranded region, or comprise nucleotides at positions in the double-stranded region and are no more than three nucleotides away from an end of the single-stranded region.

In some embodiments, for every 100 pmol of the aptamer candidates, an average of at least about six, twelve, or a higher number of copies of each possible variable sequence is represented. The m number of positions can be at least about 5. Each aptamer candidate can be about 50-60 nucleotides in length and m can be about 25, 22 or less. In one feature, each aptamer candidate has a common secondary structure. Each aptamer candidate may comprise an oligonucleotide selected from DNAs, RNAs, PNA, modified nucleotides, and mixtures of any of the above. In some embodiments, each aptamer candidate is no more than 100, 75 or 50 nucleotides in length.

In one embodiment, the aptamer library comprises at least 10⁹ distinct members. In one feature, the aptamer library may comprise a plurality of concatenated aptamers that can include two or more identical secondary structures, two or more non-identical secondary structures or a combination of identical and non-identical secondary structures.

In one aspect, the invention provides a microarray chip having the above-described aptamer library or other library embodiments of the present invention.

In another aspect, the invention further provides a method of using the library of the invention, specifically, a method for identifying an aptamer that binds to a target. Naturally, features of the library also apply to methods involving the library and are not repeated here. The method includes the steps of (a) providing an aptamer library comprising a plurality of aptamer candidates, each aptamer candidate having a primary structure of substantially the same length and a pre-selected secondary structure, the primary structure comprising at least a variable nucleotide sequence where nucleotides at m number of positions are being varied, the secondary structure comprising at least a single-stranded region and a double-stranded region, wherein the variable sequence is at least part of the single-stranded region and wherein for every 100 pmol of the aptamer candidates, an average of at least about three copies of each possible variable sequence is represented; (b) contacting the aptamer library with a target under a buffer condition that allows binding between members of the aptamer library and the target; (c) isolating at least a member of the aptamer library that is bound to the target, and (d) determining the variable sequence of the bound aptamer candidate.

In one embodiment, the above method includes an amplification step after step (c).

In one embodiment, step (c) comprises isolating a sub-fraction of the aptamer library bound to the target and wherein the method further comprises a step (e) of ranking the affinity of the bound candidate aptamers for the target according to their frequency of occurrence within the sub-fraction, as evidenced by result from step (d).

In one feature, the variable sequence has randomized nucleotides at some position and invariant nucleotides at other positions. In another feature, the variable sequence comprises randomized nucleotides at all positions.

In an embodiment, the above-described method of identifying an aptamer that binds to a target comprises a washing step after the contacting step, wherein the aptamer candidates that do not bind to the target are washed away by a buffer. The buffer condition of the washing step may be no more stringent than the buffer condition in the contacting step or the washing may occur in the presence of a competing oligonucleotide that comprises at least a part of the secondary structure of the aptamer candidates.

In some embodiments, the target comprises a polypeptide sequence, a nucleotide sequence, a lipid or a carbohydrate. In other embodiments, the target comprises a peptide, nucleotide, lipid or carbohydrate moieties at the surface of a virus, or cell. The target can be immobilized on a solid support. In one feature, the target comprises a small molecule. The small molecule may have a molecular weight of 1000 or less. In one feature, the target may comprise a label.

In one feature, step (d) of the method is accomplished through high throughput sequencing technology. In an embodiment, the high throughput sequencing technology is capable of generating at least 10,000 sequences in the library subsequent to step (c).

In yet another aspect, the invention provides a method of identifying a candidate aptamer sequence that binds to a target, comprising the steps of (a) providing an aptamer library comprising a plurality of aptamer candidates, each aptamer candidate having a primary structure and a pre-selected secondary structure, the primary structure comprising at least a variable nucleotide sequence, where nucleotides at m number of positions are being varied, the secondary structure comprising at least a single-stranded region and a double-stranded region, wherein the variable sequence is at least part of the single-stranded region and wherein for every 100 pmol of the aptamer candidates, an average of at least about three copies of each possible variable sequence is represented, (b) dividing the aptamer library into pools of aptamer candidates, each pool comprising 4m aptamer candidates, wherein m represents the number of randomized nucleotides within the variable sequence of each aptamer candidate, (c) affixing each of the pools to a distinct feature on a support, (d) contacting the support with a target (e) identifying features that exhibit sufficient binding to the target above a pre-determined level, (f) subsequently devising sub-pools from any candidate pool associated with each feature identified in step (e), each of the sub-pools comprising a fraction of distinct candidate aptamers contained in the candidate pool, (g) repeating steps c) through f) until at least one of the sub-pools has only aptamer candidates of the same variable sequence and identifying the variable sequence of the aptamer candidate in the at least one sub-pool obtained in step (g).

In some embodiments, the solid support is a microarray chip or a filter substrate. In an embodiment, the sub-pool is identified through gel shift.

In one embodiment, the number of the randomized nucleotides, m, within the variable sequence of each aptamer candidate is about 25, 22 or less.

In a further aspect, the invention provides a method for refining the desirable properties of a template aptamer by randomizing certain segments of the aptamer sequence, providing a template aptamer, introducing randomized sequences into a segment of the template aptamer, applying any one of the above described methods of identifying a candidate aptamer sequence that binds to a target, and determining which of the randomized sequences within the segment increases the binding affinity of the template aptamer for the target.

The template aptamer can be a SELEX-derived aptamer. The binding affinity for the target can be determined by fluorescence polarization. The target may be labeled.

In yet another aspect, the invention discloses an aptamer-based biosensor comprising (a) a test aptamer capable of binding to a target, the test aptamer being selected from an aptamer library comprising a plurality of aptamer candidates, each aptamer candidate having a primary structure and a pre-selected secondary structure, the primary structure comprising at least a variable nucleotide sequence, where nucleotides at m number of positions are being varied, the secondary structure comprising at least a single-stranded region and a double-stranded region, wherein the variable sequence is at least part of the single-stranded region and wherein for every 100 pmol of the aptamer candidates, an average of at least about three copies of each possible variable sequence is represented and (b) a detection moiety, attached to the test aptamer, wherein the absence of binding of the target to the test aptamer permits detection of a signal from the detection moiety.

The detection moiety can be an oligonucleotide and the oligonucleotide can include a fluorescence donor and either a fluorescence acceptor or a fluorescence quencher. Binding of the target to the test aptamer can induce a conformational change in the detection moiety that causes a change in the fluorescence signal.

In yet a further aspect, the invention provides a diagnostic kit for identifying the presence of a target in a sample, comprising (a) a test aptamer capable of binding to a target, the aptamer being selected from an aptamer library comprising a plurality of aptamer candidates, each aptamer candidate having substantially the same length and having a primary structure and a pre-selected secondary structure, the primary structure comprising at least a variable nucleotide sequence where nucleotides at m number of positions are being varied, the secondary structure comprising at least a single-stranded region and a double-stranded region, wherein the variable sequence is at least part of the single-stranded region, and wherein for every 100 pmol of the aptamer candidates, an average of at least about three copies of each possible variable sequence is represented, (b) reagents for performing the binding reaction between the test aptamer and the target, and (c) instructions for the use of the diagnostic kit in identifying the presence of the target in a test sample.

Features and embodiments described with regard to one aspect of the present invention, as would be obvious to one skilled in the art, often apply to other aspects of the invention and are not repeated here. For example, features described with regard the library generally apply to the biosensor and the diagnostic kit aspect of the invention as well.

It should be understood that this application is not limited to the embodiments disclosed in this Summary, and it is intended to cover modifications and variations that are within the scope of those of sufficient skill in the field, and as defined by the claims.

The embodiments described here have many advantages over SELEX and other similar methods for aptamer discovery. The herein described HTSA procedure employs a comprehensive library of short nucleic acid sequences having a pre-defined secondary structure in which every possible variant sequence is represented by at least one copy in the library. Selection and sequencing of candidate aptamers that bind to a target occur after just one round of binding to the target. HTSA methodology therefore resolves many of the limitations of current aptamer discovery technology by improving throughput, cost, the diversity of the sequences screened as well as the time needed to validate candidate aptamers.

### BRIEF DESCRIPTION OF THE DRAWINGS

FIG. 1 depicts a thrombin-specific aptamer selection protocol using the HTSA procedure.

FIG. 2 shows (a) the SELEX-derived thrombin binding aptamer (TBA) including the G quartet feature and (b) SELEX-derived PDGF binding aptamer.

FIG. 3 depicts a hairpin loop HT-aptamer with a 8 base-pair stem and non-complementary tails.

FIG. 4 depicts a thrombin aptamer selection using the HTSA procedure.

FIG. 5 depicts Aptamer motifs for (a) hairpin loops, (b) three-way junctions, (c) internal/bulge (i/b) loops, and (d) pseudoknots. Parallel lines denote base-paired regions, thin lines denote a fixed sequence, and thick lines indicate randomized sequences.

FIG. 6 shows the experimental scheme for aptamer-adaptor ligation in preparation for high throughput sequencing.

FIG. 7 schematically compares the HTSA approach with SELEX.

FIG. 8 Schematic for screening libraries for 6-base hairpin loops. Mixed site residues, N, include roughly equal amounts of A, C, G, T. Fixed bases defined from the previous round of screening are in bold font.

FIG. 9 depicts the application of HT-aptamers or probes and the AlloSwitch technology to discovery of drug.

FIG. 10 graphically illustrates further analyses of selected sequences: a, Phylogenetic tree of sequences with ≧10 counts. b, SPR analysis of the motifs top contenders. The SPR signal, Δ%R=change in reflectivity of the chip surface in response to analyte. Motif III with counts comparable to TBA did not exhibit high affinity for α-thrombin. c, Confirmation of the correlation between counts and affinity. 4 TBA motif sequences (shown in Table. I) with varied counts had SPR responses congruent with their counts. d, Normalized log[counts] vs. SPR signal of the 4 sequences for 3 replicate experiments present a high degree of reproducibility.

FIG. 11 shows Motif III sequences bind carbohydrate moieties. Analysis of motif III's top contender (sugar-aptamer-candidate (SAC)) (top), TBA (bottom) and a poly-A control sequence (middle) with (a) glucose and (b) α-methyl-mannoside revealed SAC's superiority for substrates. TBA predictably exhibited competitive affinity for both sugars as G-rich sequences have been reported in carbohydrate aptamers, with some reports attributing the binding abilities to G-quartets^{24,25}. c, d GMSAs showed SAC's affinity for α-thrombin diminishing on addition of Con-A, a competitor for thrombin's carbohydrate elements and vanishing on addition of glucose a preferred substrate. All DNA hairpins consistently had two bands in GMSAs.

FIGS. 12a and 12b illustrate N3-N6 DNA hairpin loop library (5440 total sequences, 106 library pools).

FIG. 13 shows two expanded DNA hairpin loop libraries: (a). N6-56-57 chip hybridization with Cy3-NCp7 (b). N6-56-57 chip layout (c) showing control features in white, N6-57 and N6-56 library features in tan and blue respectively. Sequences in bold were selected for further analysis.

FIG. 14 depicts DNA microarray chip setup showing an expanded array layout (a). Microarray chip hybridized with SYBR 555 DNA stain (b).

FIG. 15 shows N3-N6 chip hybridized with Cy3-NCp7 (a). N3-N6 chip layout showing control features in white and library features grouped by color according to loop size and complexity as shown in Table 1 (c).

FIG. 16 is a histogram from Cy3-NCp7/N3-N6 library chip screens. Averaged intensity values for each feature represent the average total intensity of 4 replicates, normalized relative to GUG. Positive and negative control features (left light group), and features having complexities of 64 and 256 are the middle darker group and right lighter group, respectively.

FIG. 17 shows NCp7 Trp37 fluorescence intensity vs. mole ratio of oligo/protein for control sequences (blue), hits (red) and non-hits (light green) from expanded “hit” library pool N6_{—}56(64), and non-hits (dark green) from expanded “non-hit” library N6_{—}57(64). Black 1:1 line represents an infinite binding constant. Each sequence name followed by calculated K_{d} in parenthesis.

### DETAILED DESCRIPTION

Unless defined otherwise, all technical and scientific terms used herein have the same meaning as is commonly understood by one of skill in the art. The following definitions are provided to help interpret the disclosure and claims of this application. In the event a definition in this section is not consistent with definitions elsewhere, the definition set forth in this section will control.

As used herein, the term “about” or “approximately” when used in conjunction with a number refers to any number within 5, 10 or 15% of the referenced number.

The term “plurality”, as used herein, refers to a quantity of two or more.

As used herein, “nucleic acid,” “oligonucleotide,” and “polynucleotide” are used interchangeably to refer to a polymer of nucleotides of any length, and such nucleotides may include deoxyribonucleotides, ribonucleotides, and/or analogs or chemically modified deoxyribonucleotides or ribonucleotides. The terms “polynucleotide,” “oligonucleotide,” and “nucleic acid” include double- or single-stranded molecules as well as triple-helical molecules. An oligonucleotide may have any number of nucleotides theoretically but preferably 2-200 nucleotides, more preferably 10-100 nucleotides, and yet more preferably 20-40 nucleotides.

“Enumerate” refers to a series of positions in an oligonucleotide sequence. An enumerated position will have only one of several different bases (generally G,A,T,C, or U) at that position. The enumerated positions are generally found in a single stranded loop or bulge loop.

As used herein, “target molecule” and “target” are used interchangeably to refer to any molecule to which an aptamer can bind. “Target molecules” or “targets” refer to, for example, proteins, polypeptides, nucleic acids, carbohydrates, lipids, polysaccharides, glycoproteins, hormones, receptors, antigens, antibodies, affybodies, antibody mimics, viruses, pathogens, toxic substances, substrates, metabolites, transition state analogs, cofactors, inhibitors, drugs, small molecules, dyes, nutrients, pollutants, growth factors, cells, tissues, or microorganisms and any fragment or portion of any of the foregoing. In one embodiment, a “target” refers to a cell surface molecule, such as a cell membrane protein.

As used herein, “combimer,” “aptamer candidate” and “aptamer,” are used interchangeably and refer to an oligonucleotide that is able to bind a target of interest other than by base pair hybridization. “Aptamers” typically comprise DNA, RNA, PNA, nucleotide analogs, modified nucleotides or mixtures of any of the above. “Aptamers” may be naturally occurring or made by synthetic or recombinant means. “Aptamers” used herein comprise single stranded regions and regions of secondary structure including, but not limited to, a hairpin loop, a bulge loop, an internal loop, a multi-branch loop, a pseudoknot or combinations thereof. “Aptamers” may comprise naturally occurring nucleotides, nucleotides that have been modified in some way, such as by chemical modification, and unnatural bases, for example 2-aminopurine. “Aptamers” may be chemically modified, for example, by the addition of a label, such as a fluorophore, or a by the addition of a molecule that allows the aptamer to be crosslinked to a molecule to which it is bound. “Aptamers” or “candidate aptamers” are of the same “type” if they have the same sequence or are capable of specific binding to the same molecule. The length of the aptamer will vary, but it is typically less than about 100 nucleotides. HT-aptamers designate aptamers found in HTSA libraries and SE-aptamers designate aptamers found in SELEX libraries.

An “aptamer candidate” is an HTSA selected aptamer (sometimes referred to as HT-aptamer) that has a low, moderate or high binding affinity for a target molecule. It is recognized that affinity interactions are a matter of degree; however, in this context, the “specific binding affinity” of an aptamer for its target means that the aptamer binds to its target generally with a much higher degree of affinity than it binds to other components in a test sample.

As used herein, “a template aptamer” is an aptamer having an affinity for a target that can be improved by refinement, i.e., modification of the nucleotide sequence of an aptamer to increase or decrease the affinity of the template aptamer for the target. In one embodiment, “a template aptamer” is a SELEX-derived aptamer (sometimes referred to as SE-aptamer).

As used herein, “high affinity” binding refers to binding of a candidate aptamer to a target with binding dissociation constant K_{d} is less than 100 nMolar.

As used herein, “moderate affinity” binding refers to binding of a candidate aptamer to a target with binding dissociation constant K_{d} from 0.1 μM to 100 μMolar.

As used herein, “low affinity” binding refers to binding of a candidate aptamer to a target with binding dissociation constant K_{d} from 0.1 mM to 1000 mMolar.

As used herein, the term “library” refers to a plurality of compounds, e.g. aptamers.

As used herein, Peptide Nucleic Acids (PNAs), are nucleic acids in which the sugar phosphate backbone of the oligonucleotide is replaced by a peptide backbone comprising an amide bond.

As used herein, the term “label” or “detection moiety” refers to one or more reagents that can be used to detect interactions involving a target and an aptamer. A detection moiety or label is capable of being detected directly or indirectly. In general, any reporter molecule that is detectable can be a label. Labels include, for example, (i) reporter molecules that can be detected directly by virtue of generating a signal, (ii) specific binding pair members that can be detected indirectly by subsequent binding to a cognate that contains a reporter molecule, (iii) mass tags detectable by mass spectrometry, and (iv) oligonucleotide primers that can provide a template for amplification or ligation. The reporter molecule can be a catalyst, such as an enzyme, dye, fluorescent molecule, quantum dot, chemiluminescent molecule, coenzyme, enzyme substrate, radioactive group, a small organic molecule, amplifiable polynucleotide sequence, a particle such as latex or carbon particle, metal sol, crystallite, etc., which may or may not be further labeled with a dye, catalyst or other detectable group, a mass tag that alters the weight of the molecule to which it is conjugated for mass spectrometry purposes, and the like. The label can be selected from electromagnetic or electrochemical materials. In one embodiment, the detectable label is a fluorescent dye such as Cy-3 or Cy-5. Other labels and labeling schemes will be evident to one skilled in the art based on the disclosure herein.

The detection moiety can be detected by emission of a fluorescent signal, a chemiluminescent signal, or any other detectable signal that is dependent upon the identity of the moiety. In the case where the detectable moiety is an enzyme (for example, alkaline phosphatase), the signal can be generated in the presence of the enzyme substrate and any additional factors necessary for enzyme activity. In the case where the detectable moiety is an enzyme substrate, the signal can be generated in the presence of the enzyme and any additional factors necessary for enzyme activity. Suitable reagent configurations for attaching the detectable moiety to a target molecule include covalent attachment of the detectable moiety to the target molecule, non-covalent association of the detectable moiety with another labeling agent component that is covalently attached to the target molecule, and covalent attachment of the detectable moiety to a labeling agent component that is non-covalently associated with the target molecule. Universal protein stains are described in detail in U.S. Patent Application US20080160535. In one embodiment, the detection moiety is a molecular switch based on a FRET pair, for example, an “Alloswitch” (Orthosystems, Inc.), further described in the published U.S. patent applications US20060216692 and US20060029933.

“Solid support” refers herein to any substrate having a surface to which molecules can be attached, directly or indirectly, through either covalent or non-covalent bonds. The substrate materials can be naturally occurring, synthetic, or a modification of a naturally occurring material. Solid support materials include silicon, graphite, mirrored surfaces, laminates, ceramics, plastics (including polymers such as, e.g., poly(vinyl chloride), cyclo-olefin copolymers, polyacrylamide, polyacrylate, polyethylene, polypropylene, poly(4-methylbutene), polystyrene, polymethacrylate, polyethylene terephthalate), polytetrafluoroethylene (PTFE or Teflon®), nylon, poly(vinyl butyrate)), germanium, gallium arsenide, gold, silver, etc., either used by themselves or in conjunction with other materials. Additional rigid materials can be considered, such as glass, which includes silica and further includes, for example, glass that is available as Bioglass. Other materials that can be employed include porous materials, such as, for example, controlled pore glass beads. Any other materials known in the art that are capable of having one or more functional groups, such as any of an amino, carboxyl, thiol, or hydroxyl functional group, for example, incorporated on its surface, are also contemplated. The solid support can take any of a variety of configurations ranging from simple to complex and can have any one of a number of shapes, including a strip, plate, disk, rod, particle, including bead, tube, well, and the like. The surface can be relatively planar (e.g., a slide), spherical (e.g., a bead), cylindrical (e.g., a column), or grooved. Exemplary solid supports include, but are not limited to, microtiter wells, microscope slides, membranes, paramagnetic beads, charged paper, filters, gels, Langmuir-Blodgett films, silicon wafer chips, flow through chips, microarray chips, microbeads and magnetic beads.

As used herein the term “amplification” or “amplifying” means any process or combination of process steps that increases the amount or number of copies of a molecule or class of molecules. In one embodiment, “amplification” refers to a polymerase chain reaction (PCR).

As used herein, primary structure of an oligonucleotide refers to its nucleotide sequence.

As used herein, “secondary structures” of an oligonucleotide refer to RNA or DNA secondary structures including, but is not limited to, a hairpin loop, a bulge loop, an internal loop, a multi-branch loop, a pseudoknot or combinations thereof.

“Pre-selected secondary structures” refers to those secondary structures that are selected and engineered into an aptamer by design.

As used herein, a “variable sequence” or a “variable nucleotide sequence” refers to a base sequence within an aptamer that includes at least one enumerated or randomized position. In some embodiments, “a variable sequence” also includes invariant nucleotides where the nucleotide sequence at that location is the same amongst all members of a given population of aptamers, as long as there is at least one other base that is not constant. In one embodiment, a variable sequence is confined to a single-stranded region of an aptamer. In another embodiment, a variable sequence comprises nucleotides at positions in the double-stranded region and are no more than three nucleotides away from an end of the single-stranded region. “A variable nucleotide sequence” can be at least 2, at least 5, at least 10, at least 15, at least 20 or at least 25 or 50 nucleotides in length.

A “double-stranded region” refers to a region of an aptamer where two single stranded regions have sufficient complementarity to base-pair with each other. Double-stranded regions may have an invariant sequence. In some embodiments, the inclusion of randomized sequences within a region originally intended as single-stranded may permit varied stem positions because randomized positions may be able to base pair with each other thus extending the double-stranded region into a previously single stranded region. In other words, the “single stranded” region of some candidate aptamers may include varied loop positions that may adopt structures with Watson-Crick or non-canonical pairs, triples, quadruples.

As used herein, a concatenated aptamer is a continuous nucleic acid molecule that contains one or more repeats of base sequences linked in series. The linkage may be covalent or non-covalent. In one embodiment, concatenated aptamers comprise two or more identical secondary structures. In another embodiment, concatenated aptamers comprise two or more non-identical secondary structures. In yet another embodiment, concatenated aptamers comprise a combination of identical and non-identical secondary structures.

Buffer conditions refer to the chemical nature of the buffer, pH, added salts, denaturants, detergents, mole ratio of target to aptamer candidates, and other parameters well known to those skilled in the art of modulating target interactions with nucleic acids.

As used herein the term “stringency” is used in reference to the conditions of temperature, ionic strength, and the presence of other compounds such as organic solvents, under which binding assays are conducted.

As used herein, “over-sampling” or “ample-sampling” means that each distinct aptamer sequence has on average at least one, preferably multiple copies in a library and that substantially all possible sequences within a variable nucleotide sequence are represented in a library.

As used herein, “sparse sampling” means that not all possible sequences are present in a library.

As used herein, the term “small molecules” and analogous terms include, but are not limited to, peptides, peptidomimetics, amino acids, amino acid analogs, polynucleotides, polynucleotide analogs, nucleotides, nucleotide analogs, other organic and inorganic compounds (i.e., including heteroorganic and organometallic compounds) having a molecular weight less than about 10,000 grams per mole. In some embodiments, the term refers to organic or inorganic compounds having a molecular weight less than about 5,000 grams per mole, less than about 1,000 grams per mole, less than about 500 grams per mole, less than about 100 grams per mole. Salts, esters, and other pharmaceutically acceptable forms of such compounds are also encompassed.

I. HTSA Screening

In one aspect, the present invention can be practiced using an “in solution” approach where the HT-aptamer library is provided in a solution where it binds to a target immobilized on a solid support. The bound aptamers are then eluted from the target, ligated with adaptor sequences, and PCR amplified prior to high-throughput sequencing. The identity and frequency of occurrence of each bound aptamer is therefore determined by sequencing.

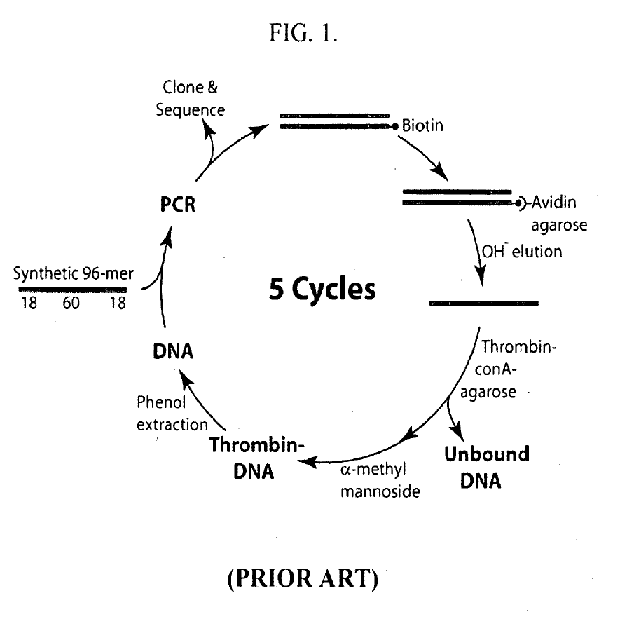

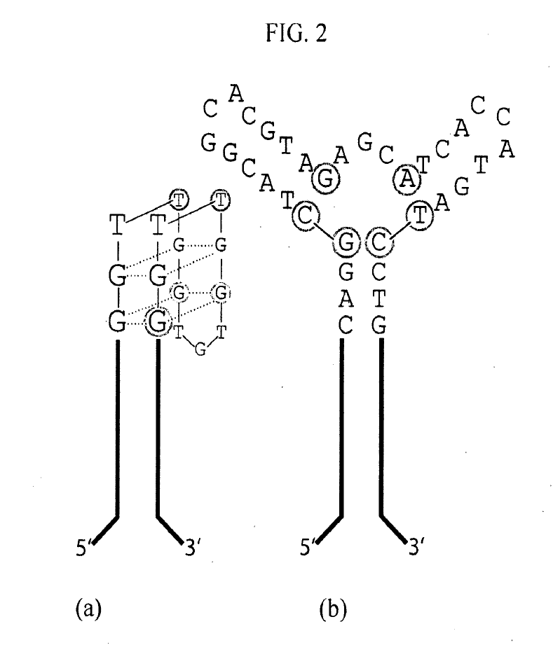

Current aptamer discovery technologies based on SELEX require successive rounds of enrichment of candidate aptamers starting from a highly complex pool of 10¹⁴ distinct, fully randomized SE-aptamer candidates of 30 to 120 nucleotides in length. As shown in FIG. 1, selection for SE-aptamers that bind to a target can be accomplished by affinity chromatography, where the target is immobilized on a solid support. For example, Bock et al. selected for thrombin-specific SE-aptamers (TBA) by binding them to thrombin immobilized on concanavalin A-sepharose (Bock et al. (1992) Nature 355, 564). Subsequent elution of non-bound aptamers and washing result in the selection of thrombin-specific candidate SE-aptamers that remain bound to the immobilized thrombin. After elution in the presence of α-methyl mannoside and phenol extraction, candidate SE-aptamers are then amplified by PCR using a non-biotinylated and a biotinylated primers that anneal to the extremities of each SE-aptamer. The biotinylated primer is complementary to the 3′ end of each SE-aptamer. The double-stranded PCR product is then bound to streptavidin beads and denatured in the presence of alkali which results in the elution of the enriched candidate SE-aptamer sequences. After another five to twenty rounds of repeated partitioning and PCR amplification, potential winners are cloned and sequenced. Using a similar protocol, Bock et al. isolated 32 thrombin binding aptamers (TBAs), each having the highly conserved stem-and-loop structure of FIG. 2(a), which was subsequently shown to bind with high affinity to the active site of thrombin.

Despite its initial success, the SELEX procedure remains arduous, time consuming and poorly amenable to automation. As will become apparent from this disclosure, the SELEX methodology is fundamentally flawed because the complexity of the starting library severely limits the diversity of sequences that can be present in a SELEX library. As shown in Table 1, introduction of random nucleotides at every position of a 70 nucleotide aptamer would potentially generate 4⁷⁰=1.4×10⁴² distinct aptamer candidate sequences. One hundred pmol of a 70 nucleotide aptamer library comprises just 100×10⁻¹²×6.022×10²³=6.02×10¹³ sequences. Hence, even at high concentrations, SE-libraries are very sparsely sampled and capture only a tiny fraction of the full diversity of HTSA libraries described herein. Of course, a long randomized sequence naturally contains shorter sequences, as well. For instance, Table 1 shows that all possible 20 mer sequences are represented an average of 55 times in a library containing 100 pmol of all randomized NA molecules, and all 17 mers are represented more than 3,000 times on average. However, all target-binding sequences of substantial length (20 mers, 17 mers, etc.) cannot be represented in the context of all possible secondary structures—much of the diversity in the pool would be exhausted in creating the H-bonded context. This may help to explain why, in the ˜20 years since SELEX was first reported, SE-aptamers for only ˜500 targets have been discovered.

Unlike SELEX, the HTSA procedure pre-defines the secondary structure of oligonucleotide library members and systematically limits their sequence diversity by position in the chain, thereby creating smaller, more manageable sequence pools which, taken together screen a large diversity of combinatorial sequence space. Typically, each library contains 10⁹-10¹² HT-aptamer candidates where every possible permutation of a variable sequence is present on average at least once. This is accomplished by generating relatively short HT-aptamers of just 30-50 nucleotides in length and confining the variable nucleotide sequence generally to single stranded regions and, in some instances, to adjacent double-stranded regions. In some cases, base randomization within an intended single-stranded region can result in base-pairing inside the previously single-stranded region, resulting in extension of an existing double-stranded region or formation of new double-stranded region(s).

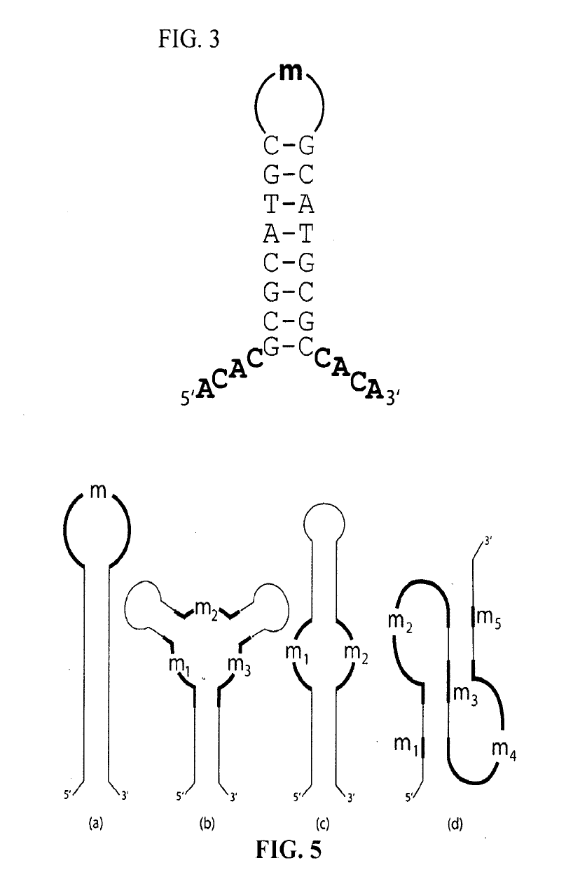

Characterization of aptamers isolated by SELEX, such as the thrombin-binding aptamer of FIG. 2(a), suggest the core-binding sequence of many aptamers can be confined to relatively simple structural motifs often in the form of a loop or bulge structures. HT-aptamer design in its simplest form is a single hairpin loop as depicted in FIG. 3. In this example, the double-stranded stem is formed by 8 base pairs that encompass a single-stranded loop region containing a variable nucleotide region. The double-stranded region may have any number of base pairs provided the base pairing is stable under suitable binding buffer conditions. In certain embodiments, the stem may include one or more bulges of variable length and sequence. The variable nucleotide sequence can be at least 1, at least 2, at least 3, at least 5, at least 10, at least 25, at least 50, at least 100 nucleotides or more in length. In some embodiments, variable nucleotide sequences may comprise one or more invariant nucleotides that may be at any pre-defined location within the loop. In other embodiments, the variable nucleotide sequence comprises “m” number of randomized nucleotides where each position can have any of the four possible nucleotides (A, T, G or C for DNA or A, U, G or C for RNA). In one embodiment, the variable nucleotide sequence includes modified nucleotides. In some embodiments, the number of randomized nucleotides, m, can be equal to at least 1, at least 2, at least 3, at least 5, at least 10, at least 15, at least 20 or at least 22, or at least 23 randomized nucleotides. In one embodiment, the complementary nucleotide sequence within the stem is invariant. In another embodiment, one of the strands of the double-stranded region may contain one or more randomized sequences. For a given HT-library, the termini of each HT-aptamer have one or more short single-stranded regions, e.g., 4-nucleotide, non-complementary head and tail sequences that facilitate adaptor annealing, prior to ligation, PCR amplification and high throughput sequencing (see below for further detail).

In one embodiment, HT-aptamers comprise any known secondary structure including, but not limited to, a hairpin loop, a bulge loop, an internal loop, a multi-branch loop, a pseudoknot or combinations thereof (see FIG. 5 for some examples, where the total number of variable positions is m=m₁+m₂+m₃+ . . . for panels b, c, d). In other embodiments, HT-aptamers may be concatenated, i.e., one or more repeats of identical or non identical HT-aptamer sequences.

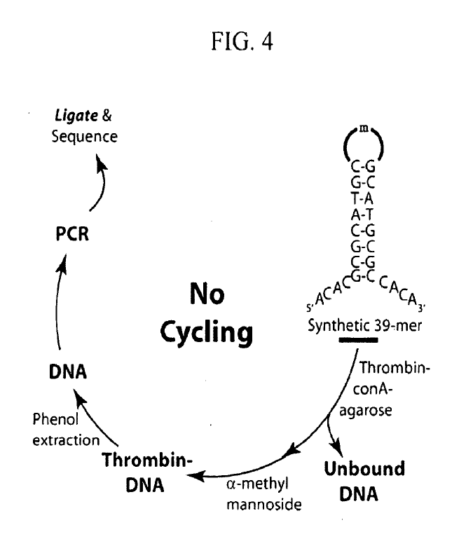

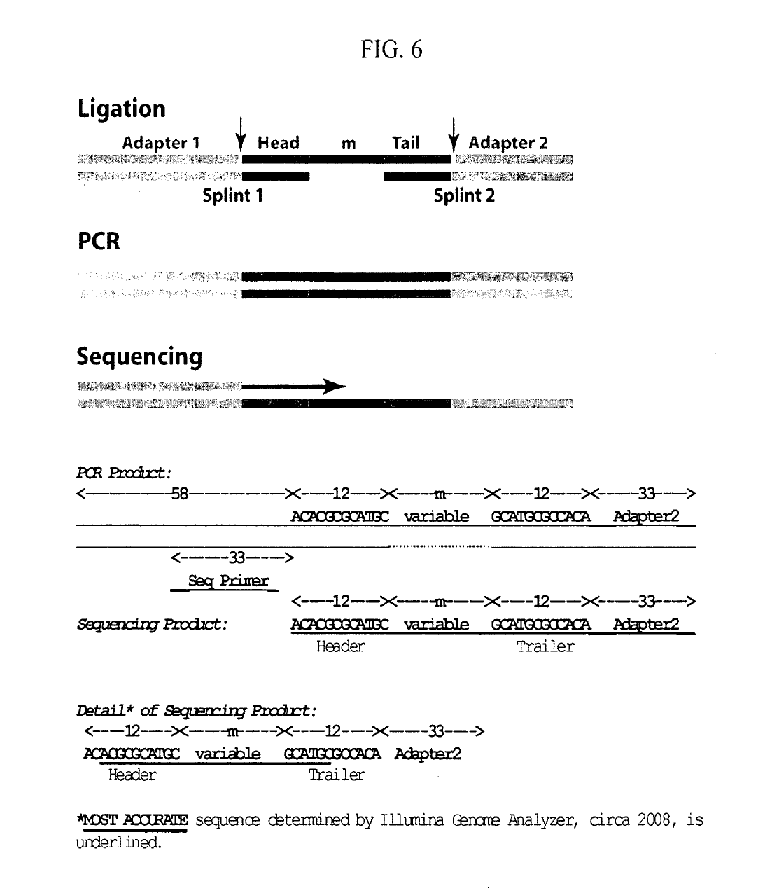

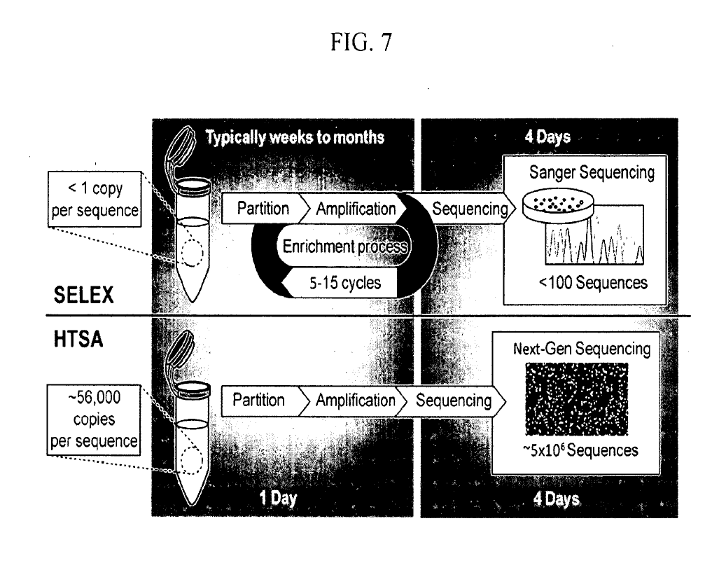

Moreover, HTSA library design permits direct screening of the library in a single partitioning/PCR amplification step. As illustrated in FIG. 4, in an embodiment, an HTSA library is first partitioned by affinity chromatography where a target, such as thrombin, is immobilized to a solid support, e.g., a concanavalin A-sepharose. After washing, elution and phenol extraction to purify HT-aptamers bound to thrombin, the tails of each HT-aptamer are annealed to adaptors, ligated, optionally PCR-amplified and sequenced using a high throughput sequencer (ABI SOLiD, Illumina Solexa, Roche 454 Life Sciences, etc.). Using ⅛ of a chip on an Illumina (Solexa) HT sequencing platform available in 2008, up to 6×10⁶ sequences can be determined at once with an optimal read length of 35-40 nucleotides. HTSA methodology therefore provides a significant increase in throughput over SELEX and reduces the discovery process, typically weeks, to days, with no automation required. The two methods are compared in FIG. 7.

The under-sampling limitations seen with SE-aptamer libraries are resolved by HTSA. To understand how, Table 1 shows the changes in the sequence redundancy and complexity in 100 pmol of an HT-aptamer library as the number “m” of randomized nucleotides increases from 1 to 120. In 100 pmol of a candidate aptamer pool where each aptamer candidate is ˜15 nt in length, there are approximately AM=6.02×10¹³ aptamer candidates in the pool. The number of unique sequences of length m is equal to 4^{m}. For instance, there are pₘ=4⁵=1,024 unique loops with m=5. The number of copies of each unique sequence is therefore equal to 6.02×10¹³/1024=5.9×10¹⁰. When m−15, there are approximately 56,000 copies of each unique sequence in the pool and a 0.006 chance that any particular HT-aptamer is counted without PCR.

An issue involved in sampling all possible HT-aptamers only becomes apparent when in is about 22 and there are only on average about 3 copes of each distinct sequence in the pool. This represents a threshold number of HT-aptamers that can be detected and sequenced after PCR amplification using current Illumina (Solexa) high throughput sequencers. With the use of more than 100 pmol in the selection step and with even newer generations of sequencers a threshold of m=23, 24, or 25 will become practical. Single-molecule sequencers are due to come on the market soon that require no PCR step. These are especially attractive for the in-solution mode of HTSA.

A fundamental limitation of all aptamer discovery methods, including HTSA, is that the partitioning step of contacting the pool with the target is never 100% efficient to remove unbound or weakly bound candidates. There will be thousands to millions of randomly selected molecules that are sequenced—this represents background “noise” in the experiment. Other non-binding or weakly binding candidates will be carried forward to the sequencing step in HTSA. In the example of a 100 pmol of hairpin loops with m=15, sampling 6×10⁶ sequences, and no partitioning step, the Poisson distribution predicts that there will be 31 instances where a random hairpin will be sequenced three times, and nearly 17,000 times where a random hairpin will be sequenced twice.

A conservative noise floor can be set by the Poisson distribution by those skilled in the art of DNA sequence analysis. A sequence that is determined from the partitioned pool should be considered as a possible binding candidate if it occurs more often than the Poisson estimate for multiple appearance of random sequences. A hairpin candidate that appears at three times or more in the partitioned pool can be considered a “signal” in the example of m=15 and 6×10⁶ sequences determined. As will be seen below, known high affinity aptamers appear thousands of times for targets from such libraries.

In one embodiment, increasing the stringency in the partitioning step may reduce non sequence-specific binding. For example, the ionic strength of the buffer may be increased or competition oligonucleotides, e.g., those containing a part of the double-stranded regions of the candidate HT-aptamers, may be added to the binding buffer.

A person of skill in the art will recognize selection of target-specific aptamers can be accomplished using a variety of partition methods known in the art including by not limited to, immunoprecipitation, gel shift assays, kinetic capillary electrophoresis, size fractionation and various bead assays requiring fractionation by centrifugation or by application of a magnetic field.

The HTSA method inherently identifies alternative HT-aptamers that have a wide range of affinities for the target. To compare the affinity and specificity of the different candidate HT-aptamer sequences, DNA-protein microarrays may be screened using fluorescently tagged proteins or by Surface Plasmon Resonance (SPR) for low throughput, label-free analysis. Also, validated HT-aptamers can be exposed to microarray analysis with other protein targets that are likely to be cross-reactive to determine HT-aptamer specificity.

Surface Plasmon Resonance (SPR) is a label-free method to determine kinetic on-rates and off-rates, and hence the equilibrium constant, K_{d}, for dissociating an aptamer-target complex. Biotinylated aptamer candidates can be attached to the surface of an SPR microarray chip. Any increase in mass associated with binding the protein target is then measured. Hence, the instrument can usually detect whether the complex has a 1:1 or different stoichiometry. Although SPR has lower throughput than HT-sequencing or microarray analysis (see below), it is still capable of high enough throughput to evaluate the top 100+ of the most interesting candidate aptamers that pass the sequencing and microarray tests.

The HTSA method may also adapted to refine previously identified aptamers, such as SELEX-derived aptamers, by introducing targeted mutations into a selected region or regions of the aptamer and determining the affinity of the refined aptamers for its target.

II. Multiplex Library

In another aspect, the present invention can be practiced using a multiplex approach, where the HT-aptamer library is divided into pools that are immobilized at one of up to 10⁶ or more locations on a solid support, e.g., a microarray chip. Each pool is designed to contain a defined number of enumerated bases within the HT-aptamer's variable sequence from which a predictable number of distinct aptamers of known sequence can be deduced. Binding of the target molecule to a specific location then indicates at least one of the HT-aptamers within the pool at that location contains a binding site for the target. By designing a second microarray chip where each location contains only one of the aptamer candidate species predicted to be found in each sub-pool and repeating the binding to the target, it is possible to determine the identity of any HT-aptamer that binds to the target without the need for direct sequencing.

This aspect of the present invention provides a method that is simpler, more defined and more flexible than the existing in vitro selection methods with respect to both the chemical nature of the oligomer libraries being screened and the resulting high affinity target sequence. The present procedure also affords a huge increase in throughput compared to in vitro selection when many target species are being investigated.

Given the universe of possible sequences in SELEX experiments (e.g., 1×10¹⁸ for a random 30-nucleotide stretch), direct synthesis and screening of all sequences is impossible, even given the high-throughput advancements made in DNA/RNA synthesizer instrumentation. This “under-sampling” problem means that in a typical SELEX library, a significant number of candidate sequences is not even present in the library. By contrast, in one application of the present invention, a procedure has been devised to systematically limit library members' sequence diversity by a position-driven approach. Specifically, an embodiment of the present method sequentially holds a predetermined number of, e.g., two, positions invariant—just within a subset of the library—in the chain of the variable sequence under examination, thereby creating smaller, manageable subsets (i.e. features on a chip). Taken together, these smaller subsets are used to screen a large diversity of combinatorial sequence space. We sometimes refer to this multiplex library screening approach as the Combigen method. As described above, the secondary structures of members of such an aptamer library are defined or pre-selected.

In essence, the present invention solves the above-noted “under-sampling” problem in SELEX methodology by dividing the sequence complexity of a library amongst subsets of degenerate pools. If the total sequence complexity is 4^{m}-meaning, the total length of the variable sequence is “m”—and “n” number of nucleotides are chosen to be held invariant in a subset, then 4⁶ of subsets are needed but each subset will only need 4^{(m-n)} distinct sequences to warrant the same desired sequence complexity. By manipulating the 4^{(m-n)} number, a given feature's physical limitation can now comfortably accommodate the number of oligonucleotides needed to guarantee the sequence complexity desired of each subset—in fact, each distinct sequence can be represented in a subset by a sufficient number, e.g., an average of about 3 copies, preferably 4, 5, 6, 7, 8, 9, 10, and more preferably 12 or even higher copies, resulting in “ample-sampling” or “over-sampling” to guarantee the completeness of the multiplex library.

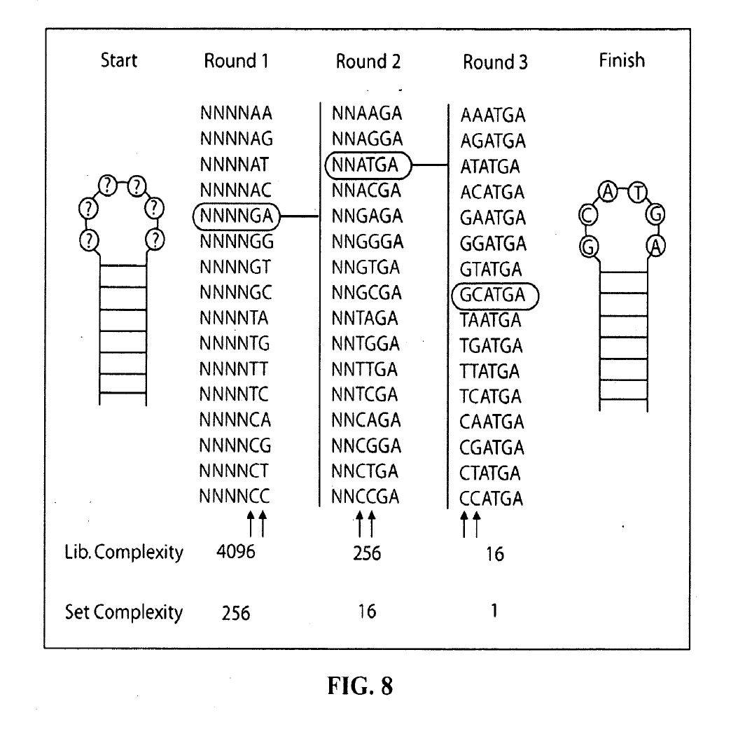

FIG. 8 illustrates the library design and screening concept using a 6-position (N6) hairpin loop library (i.e., m=6). For a complete N6 library, there are 4⁶=4096 distinct sequences (with four possible nucleotides for each base position), if we examine sequence affinity two bases at a time (i.e., n=2), we divide the N6 library into 16 (i.e., 4ⁿ=4²) subsets of smaller libraries (N6-2 libraries). In round 1, each of the 16 N6-2 library has a subset of aptamer candidates each with a variable sequence that can be represented as “NNNNαβ” where α and β are invariant within a given N6-2 subset library. The α and β positions, the relatively invariant positions within a given round, are marked with arrows in FIG. 8. Each of the 16 subset libraries, characterized by a unique combination of αβ, will contain 256 (i.e., 4^{(m-n)}=4⁴) possible sequences resulting from random substitution at the four leading positions (noted as “N”). Because 256 is much less than 4096, with a cap on the number of oligonucleotides or aptamers that a microarray chip feature can accommodate, each distinct sequence has a much better chance of being represented in the feature.

Still referring to FIG. 8, after the nucleotides of interest for the α and β positions have been determined in Round 1 (e.g., derived from the subsets of libraries exhibiting relatively high affinity to the target), two more nucleotides are held invariant in each of the subsequent rounds. In each subsequent round, 16 further subsets of libraries are generated based on one or more subset libraries selected from a previous round.

Assuming GCATGA is the ultimate high affinity aptamer sequence for the loop, then Round 1 will have a hit for NNNNGA, Round 2 will have a hit for NNATGA, and Round 3 will reveal GCATGA. Thus, for a N6 library, three rounds of 16 N6-2 subset syntheses (or 3 chip screens) are sufficient to discover an especially tight-binding aptamer. In Round 2, since “GA” has been determined as part of the overall variable sequence, the total sequence complexity required of that round is 256. And through division into subsets, the sequence complexity for each subset within Round 2 is further reduced to 16. The presumed hit sequence of Round 2, “NNATGA,” is represented in Round 1 already, albeit in much smaller number in the “NNNNGA” subset library. Accordingly, positive sequences are further enriched in each subsequent round, and stronger binding signals can be expected if all other conditions remain similar.

One of the key values of the above approach lies in how a defined space of sequences are systematically divided into sequence pool or library sets, providing a context in which sequences of a desired affinity can be located and monitored as the resolution of selected library set are expanded in subsequent screens. Thus, the present invention enriches the number of each of the aptamer candidates within a feature to avoid inadequate or sparse sampling of the library. Desired affinity can be affinity above a pre-determined level, e.g., as measured through binding dissociation constant K_{d}. In one embodiment, the desired affinity is relatively higher affinity among all the candidates as determined by the strength of a signal that results from the binding in all the library subsets. In other embodiments, the desired affinity is weak affinity, moderate or, preferably, high affinity. Referring back to Table 1 and as described earlier, for every 100 pmol of aptamer candidates about 50 nt in total length, the present invention can provide about 1 copy on average for a variable sequence that is 23 nt in length, about 3 copies on average for a variable sequence that is 22 nt in length, and about 14 copies on average for a variable sequence that is 21 nt in length.

There are a number of methods and media that can be used to examine the affinity of these library sets: chips, filters, gel shifts, or any other means commonly known in the art as suitable for testing binding affinity. In one embodiment, microarray chips are used as a fast, low cost means of comprehensively and comparatively measuring the affinity of millions of oligonucleotide/aptamer features against a target in a parallel, high throughput format.

In one example, the target is a protein. Several groups have used DNA microarrays to study protein-DNA interactions (7,8); much of this work focusing on identifying putative transcription-factor (TF) binding sites (9-11). Bulyk et al have defined these chips and the technique, “Protein Binding Microarrays” or PBM technique respectively. These library chips are designed such that each feature of the microarray represents a completely defined, double-stranded (ds) DNA library sequence for profiling putative binding sites for DNA-binding proteins such as TF's (11-14). These dsDNA features are typically generated by primer extension or self-hairpinning sequences (15). In contrast, the present approach, as it would apply to microarrays, would routinely use multiplexed features in initial and subsequent screens until the resolution is such that each feature represents one defined sequence on the final chip. Also, the “sweet spot” of the present multiplex library constructs is within a pre-defined secondary structure, e.g., a hairpin loop, bulge or junction and not within a dsDNA helix. Furthermore, most of the PBM studies use antibody based detection methods; while we do not rule out that possibility, in a preferred embodiment, the present invention utilizes direct labeling. Microarray chips have been used to study aptamers (16-18); however these studies were focused on presenting chips as a general method for characterizing aptamer hits generated from the SELEX process. These aptamer chips used a completely defined sequence on each feature.

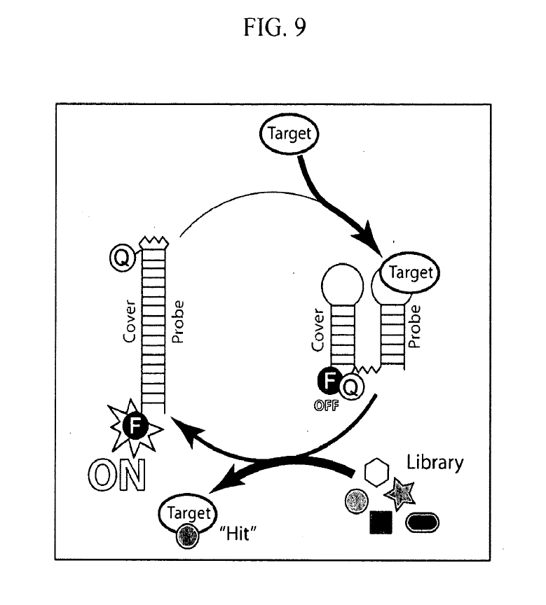

In an application embodiment, the target-specific aptamers are incorporated switchable sensors, as described in the published U.S. patent applications US20060216692 and US20060029933. For example, the AlloSwitch is a molecular switch that changes its shape upon binding its cognate target. The shape change is coupled to a fluorescent or luminescent reporter. The heart of an AlloSwitch sensor is a nucleic acid probe (HT-aptamer) that has a high affinity for the target (FIG. 9). For example, in the case of the HIV-1 nucleocapsid protein (NC) switch, the probe sequence comprises a four-base hairpin loop, which is derived from the natural RNA loop that binds NC domains in the gag-precursor protein to package genomic RNA into new virus particles. The technology can be applied to a wide array of targets, producing rapidly responding indicators for (i) drug discovery against proteins that do not naturally bind RNA or DNA, (ii) contaminants of public water supplies including cryptosporidium, giardia, and coliforms, (iii) bio-terror agents, and (iv) a host of other targets with clinical or environmental interest.

As shown in FIG. 9, AlloSwitch technology can be applied to drug discovery for potentially any target. The Probe or HT-aptamer binds the target in the right-hand form, flipping the switch from ON to OFF. A high-affinity drug candidate displaces the switch from the protein, turning the switch ON. In general, the right-hand species is the O-form, where the probe is Open, while the probe is Hidden in the left-hand H-form. FIG. 9 also illustrates several features of AlloSwitch technology. The switch molecules can be either DNA and/or RNA aptamers, with a fluorophore (F) and a quencher (Q) attached to the chains. In the absence of target, most switches are in the (fluorescent) on-state of the switch (at the left of FIG. 9) where Q and F are far apart. In this state the important binding elements of the probe are sequestered in base-pairs with the cover strand. Addition of the target flips the switch to the (quenched) off-state where Q is in close proximity to F. In the off-form the probe often adopts an unusual folded structure with unpaired bases or non-standard hydrogen bonding. A key element of the AlloSwitch is the ability to set the switch's trigger to respond to small amounts of target. The ratio of off/on molecules, K1, can be tuned by optimizing the sequence of the cover strand of the switch. in one embodiment, the ratio of off/on molecules, K1, is at least 0.01 and less than 0.1 in the absence of target.

### EXAMPLE 1

### Screening of Aptamers From Oversampled, Structured Libraries

The 15-base canonical TBA sequence, described above and shown in FIG.2(a), was discovered after 5 rounds of selection from a sparsely sampled 60 mer SELEX library and the sequencing of 32 clones [Bock et al, (1992) Nature, 355, 564-566]. To test the efficacy of the HTSA selection methodology, the complete sequence space of a m=15 hairpin HT-aptamer library was probed for HT-aptamers capable of specific binding to alpha-thrombin. Subsequent to the thrombin selection study, an aptamer candidate specific for the hexose sugars—glucose and particularly α-methyl-mannoside was also serendipitously identified. This finding was accidental as glucose was present from its role as the stabilizer for the affinity beads and α-methyl-mannoside was the elution agent. In addition to the direct isolation of aptamers, HTSA also demonstrates that it can be effectively used for direct exploration of aptamer sequence space by providing a comprehensive picture of high-, moderate- and low-binding sequence variants without the need for mutation studies or truncations to find the core binding sequences.

As noted above, two elements of HTSA's selection step expedite the discovery process. (1) The employment of combinatorial libraries with relatively short (<22 bases) degenerate regions allows full coverage of all possible sequences at relatively low library concentrations. (2) The library is oversampled resulting in multiple copies of each possible sequence (see Table 1). Overrepresentation of each sequence coupled with a single partitioning step allows the determination of high affinity binders at frequencies far above the background in the 5-6 million reads generated by a new-generation sequencing instrument.

As outlined above, a short combinatorial 15 mer hairpin library with constant stem and non-complementary tail regions was first generated (stem and tail sequence as in FIG. 3). The 100 pmol library contained ˜56,000 copies of each of the 1.1 billion possible 15 mer DNA sequences. A 15 mer loop library was chosen because α-thrombin has a well characterized 15 base canonical aptamer, and the resulting short library sequences (39 nt in total) are ideally sized for the Illumina Genome Analyzer that generated 5-6 million reads of about 36 bases.

The library was constructed by application of predetermined input ratios of nucleoside phosphoramidites in a hand-mixed loop synthesis to generate equal numbers of the four bases in the randomized positions before the partitioning step. Prior to running the thrombin-partitioned sample, a dose-response analysis with 4 different specified m=15 hairpins in 1.00:0.10:0.010:0.0010 molar proportion was run without selection against a target. The counts of 3.2 million sequenced clusters were directly proportional to the dose, 1.00:0.11:0.012:0.0010, accurately representing the input population and thereby eliminating concerns of bias due to bridge amplification in the sequencing by synthesis process.

Library partitioning conditions were previously described by Bock et al. A 60:1 target:DNA ratio was maintained from the Bock et al. protocol to demonstrate the efficiency of HTSA. Due to the nature of SELEX—multiple selection and amplification “enrichment” cycles are required after starting with single copies of each sequence.

Because HTSA has a single selection step, in an embodiment, greater stringency could be implemented by reduction of the target:DNA ratio, increasing the salt concentration, adding competitors, etc., among several measures. The successful isolation of high affinity aptamer sequences at the 60:1 ratio served as confirmation of HTSA's efficiency even in conditions of low stringency. Following isolation of high affinity binders, the samples were prepared for sequencing by ligation to adapter DNA molecules required by the Illumina system and PCR amplification. Confirmation of the ligation product and PCR amplification was achieved by agarose gel electrophoresis. The purified PCR product was then analyzed in a single lane of an 8-lane flow-cell for sequencing by the Illumina Genome Analyzer.

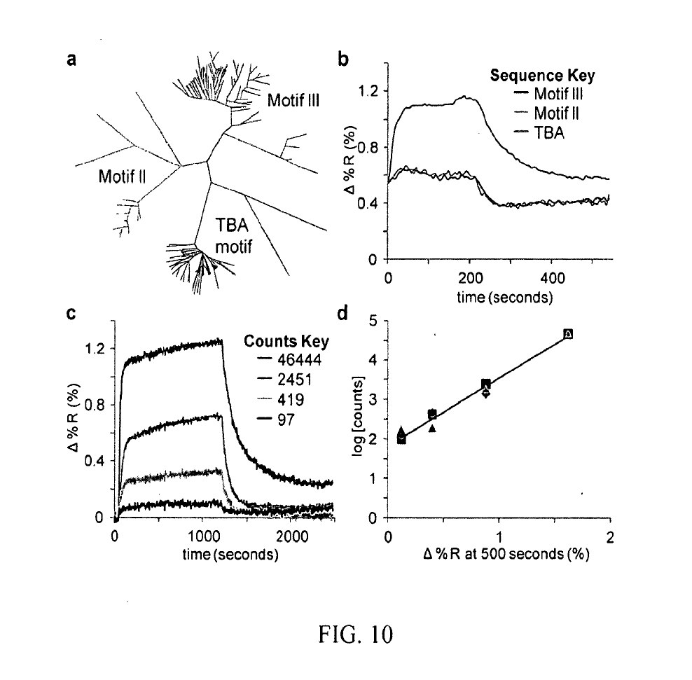

The Illumina Genome Analyzer generated ˜5 million reads per partitioning experiment. Output reads were analyzed using a custom Perl script (TABLE 2). To determine the accuracy of the generated sequences, we assessed the base calls of the constant known indexed stem and tail regions and report >95% accuracy for each base position (TABLE 3), The script also counted and ranked each output sequence by frequency, as well as generated a FASTA file that was used for sequence alignment and generation of a phylogenetic tree diagram by ClustalX and Drawtree, respectively (FIG. 10a). Clustal is a widely used multiple sequence alignment computer program to identify conserved sequence regions and to establish evolutionary relationships by constructing phylogenetic trees.

Based on the assumption that a relationship exists between the number of times a sequence is counted and its affinity for the target it is screened against, HTSA can be used to screen for aptamer sequences that bind a specific target. Of the ˜5 million reads generated, aptamer candidates were distinguishable as they occurred hundreds to thousands of times above a conservative background count of 3 determined from a Poisson distribution of a theoretical 5 million sequences data set (Table 4). The canonical TBA sequence occurred most frequently (46444 counts) while the novel α-methyl-mannoside binding sequence had the second highest count of 29,405. Both constructs lead their sequence homologues and other novel sequences. A sequence alignment and phylogenetic tree of all sequences that appeared at least 10 times revealed 3 distinct sequence motif families (FIG. 10a).

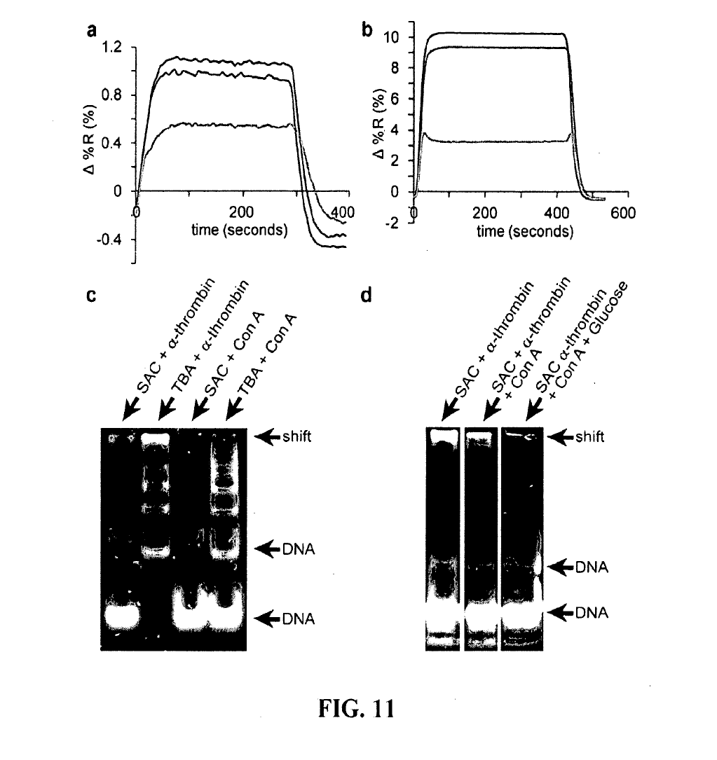

To validate the findings, the binding affinities of these sequences to α-thrombin were investigated. The highest frequency sequences from each motif family were used in binding studies by SPR analysis (FIG. 10b). The SPR signals reflected the trend of the sequencing results for all but one of the sequence motifs: motif III had counts comparable to the TBA motif but did not exhibit high affinity for α-thrombin. Possibilities of ligation and/or PCR biases by motif III sequences were ruled out by a comparative study of its top contender's ligation efficiency and amplification rate with TBA. In addition, the sequence did not bind the components of the affinity matrix, namely agarose and Con-A protein (FIG. 11c). On conducting additional SPR experiments with all individual components used in selection, motif III's top contender sequence bound most strongly to the carbohydrate moieties (FIG. 11a-b). In agreement with this finding, gel shift assays with motif III's top contender showed its slight affinity for α thrombin diminishing in the presence of Con-A. This suggested competition of Con-A for the glycosylated side chains of thrombin, which disappears on addition of glucose or α-methyl-mannoside (FIG. 11d). Affirmation of this finding was demonstrated in other HTSA experiments where higher sugar levels in the selection experiments resulted in a sequence from motif family III having a higher count (39,940) than TBA (24,484).

The dual identification of aptamer candidates for two different targets within one selection experiment substantiates the great promise of HTSA. This was revealed through secondary analysis of the relationship between counts and affinity by SPR analysis. Another contrast with SELEX is also apparent in that repeated cycles of selection and PCR lead to sequence “monsters” that can dominate the population at the expense of desirable aptamers specific for the target. HTSA is shown to be able to tolerate the sugar-binding monsters, which themselves might prove to be useful. In addition, the SPR experiment illustrated in FIG. 10c,d affirms the basic premise that aptamers in the pool will be sequenced with counts that are related to their affinity. The data in FIG. 10d show a constant relation between the log of counts from three different HTSA determinations with relative affinity as determined by SPR (sequences shown in Table 4).

HTSA's employment of new generation DNA sequencing technology allowed the efficient exploration of the sequence space of thrombin aptamer candidates. The first 108 sequences of the TBA motif were aligned and the frequency of each of base in each of the 15 possible library positions was counted. Alignment profiles display high conservation of the TBA bases GGTTGG that constitute the first half of the stacked GG structure, while the largest variability is tolerated at the G position of the TGT loop of the central loop (see FIG. 2a). The 3′-terminal positions G14 and G15 are also quite variable, however, this might occur because the immediately adjacent stem base is also a G (see FIG. 3), which might also cap the G-quartet structure in which TBA is known to fold. These findings are consistent with previous studies of the TBA G-quartet structure.

We also showed that only the aptamer candidates capable of forming a G-quartet motif could effectively inhibit the activity of α-thrombin. The canonical TBA was most effective, while TBA variants had reduced performance in the order of their counts from the HTSA experiments.

Similar results to this α-thrombin example have been obtained for a library of concatenated RNA internal and hairpin loops that bind human coagulation factor IXa. The 5′- and 3′-termini of this molecule consisted of the same DNA tails and the bottom six DNA base-pairs of the stem as in FIG. 3. An apical 6-residue RNA hairpin of fixed sequence was attached to a central internal loop region made from RNA (m₁=11 and m₂=5, overall m=16). HTSA resolved a known high affinity aptamer to Factor IXa that had a m₁=7 and m₂=1 internal loop [Rusconi et al. (2002) Nature, 419, 90-94]. The HTSA count was >50,000 in a very similar Illumina run to that described for thrombin. This factor IXa aptamer was also shown to have high affinity for factor IXa and to inhibit the activity of the protein.

HTSA bypasses the 3 slowest steps in standard SELEX aptamer generation; (1) Multiple rounds of partitioning, (2) Cloning of the sequences into plasmids, picking colonies and conducting conventional sequencing and (3) Truncation of sequences from the ends of the long chains to find the core binding sequences of aptamers. The principal expense is the cost of next generation sequencing technologies which can be reduced by multiplexed sequencing of different selection experiments. However, the largest cost in a biotechnology laboratory is for salaries of highly trained employees, so the sequencing expense is quickly recovered. In addition, newer sequencing technologies offer the chance to multiplex the sequencing runs to analyze winning sequences from different pools applied to multiple targets.

Materials and Methods

Aptamer Selection

Following elution of high affinity binders, the eluted mixture was phenol extracted twice followed by a final chloroform extraction. After concentration, adapter constructs were ligated to the candidate sequences. The ligation step was as follows: 50 μM adapter sequences and their complements were added to the partitioned DNA library and incubated at 90° C. for 3 min, ligation buffer and T4 DNA ligase (New England BioLabs) were added at 25° C. and the mixture was incubated for 30 min. DNA was extracted using a QIAquick PCR purification Kit (QIAGEN) and purified on a 2% agarose gel after which the ligation product was excised out and extracted using a QIAGEN MiniElute Gel Extraction Kit. PCR cycling conditions were as follows: Initial denaturation at 94° C. for 2 min and 18 repeats of denaturation at 94° C. for 1 min, primer annealing at 61° C. for 1 min and elongation at 72° C. for 1 min. The PCR product was purified and its length confirmed on a 2% agarose gel prior to sequencing.

DNA Sequencing Data Analysis

The Illumina Genome Analyzer (GA) generated ˜4-6 million reads per partitioning experiment. Output sequence files were analyzed using a custom Perl Script. A stringent algorithm (low penalty tolerance) was used to filter the output GA data for sequence strings that contained full length library sequences containing the 15 nt loop region. Sequences that contained ≦2 base mismatch or a single gap within the 10 bases to the 5′ side, and 4 bases to the 3′ side of the “m” degenerate library were categorized as “candidate reads”. Sequences that failed to meet these conditions were categorized as “bad reads”, and served to highlight adaptor ligation or amplification issues encountered in the experiment. The script output all parsed data into text files described further in Supplementary Data. The selection of 10 bases of the header sequence and 4 bases in the tail was a result of optimization of the script and observation that the combination was sufficient for maximum filtration of bad reads. Of the “candidate reads,” sequences with exactly 15 bases in the variable “m” region were selected as “good reads”. These sequences were subsequently input into ClustalX to generate alignments profiles and phylogenetic trees for further analysis.

Thrombin Analysis

To avoid the selection of aptamers against contaminants, the purity of α-thrombin used in the selection experiments was verified by sedimentation velocity experiments which verified a consistent ˜90% purity and ˜10% self-cleavage products. Following a 24 hour dialysis period in selection buffer, sedimentation velocity experiments of α-thrombin were performed on a Beckman XL-A instrument in which the sample was monitored using absorbance optics at 280 nm. Data was acquired over 21 h using a 6 channel cell with an epon charcoal-filled 3 mm centrepiece at a rotor speed of 50,000 rev/min at 20° C. The data was analyzed using SEDFIT using a v-bar of 0.69 mg/mL23.

SPR Analysis

Binding affinities were measured using a GWC SPRimager®II array instrument (GWC Technologies, Inc.) and 16 and 25 SpotReady™ chips. SPRdata was acquired using the V++ imagining software and analyzed in Microsoft Excel. All SPR experiments were conducted at 25° C., using selection buffer as the running buffer. For each experiment, the surface of the SpotReady™ chip (GWC Technologies, Inc.) was functionalized by incubating the chip in a 1 mM solution of 8-amino-octanethiol (AOT) (Dojindo Molecular Technologies, Inc.) in absolute ethanol at room temperature overnight, creating a self assembled monolayer. The chip was rinsed with absolute ethanol and dried under nitrogen and was incubated with 1 mM 4-(N-maleimidomethyl) cyclohexane-1-carboxylic 3-sulfo-n-hydroxysuccinimide ester (SSMCC) (Pierce Biotechnology) for an hour to create a thiol-reactive maleimide-terminated surface. Reduced 3′ thiolated DNA oligonucleotides (2 mM) were then spotted in 5 replicates per sequence onto the SSMCC treated chip and allowed to react overnight. Excess DNA was removed by washing with nuclease free water and drying under nitrogen. The chip was blocked overnight with 4 mM mPEG-thiol (MW 1000) (Nanocs) to cap all unreacted SSMCC. Once mounted on the instrument, the chip was blocked with 500 nM bovine serum albumin (Fischer Scientific), washed with 0.02% Tween-20 in selection buffer and subsequently selection buffer (without Tween-20). Binding experiments were performed with 50 nM, α-thrombin that was pumped into the flowcell at a constant flow rate for 10 min after which selection buffer was used to wash the chip.

Gel Mobility Shift Assay (GMSA)

Each DNA aptamer candidate was pre-incubated for 30 minutes in selection buffer with α thrombin, Con-A, α thrombin+Con-A, Con-A beads and Con-A beads saturated with α thrombin, all separately in both the presence and absence of 20 mM glucose and 20 mM α methylmannoside in a 60 DNA:1 protein ratio as per selection conditions. Samples were analyzed on native polyacrylamide gels (14% (w/v)) in 1×Tris/glycine running buffer at 100V for 30 min at 4° C. Immediately after electrophoresis, gels were SYBR gold stained for 1 hour, imaged and then subsequently stained with Coomassie Brilliant Blue for protein staining.

Semi-quantitative Real Time PCR (sqRT-PCR)

In an effort to confirm that the counts generated in high throughput sequencing were representative of affinity for a target and not a result of “super” amplification bias, sqRT-PCR was performed. 12 PCR reactions per aptamer candidate were prepared with equal amounts of starting template DNA and PCR cocktail reagents. PCR cycling conditions were as described for the selection process but were repeated for 30 cycles instead of 18. 2 tubes per sequence were removed at cycle 10, 14, 18, 22, 26 and 30 and their amplification rates were compared by gel electrophoresis and Nanodrop DNA concentration readings.

Thrombin Activity Assay

Clotting times were measured in duplicates using a mechanical fibrometer, Oatoclot 2 (Helena Laboratories). Normal human plasma and varying concentrations of DNA aptamer candidates (0.1 nM-700 nM) were incubated for 4 min at 37° C. before adding α-thrombin diluted in selection buffer and pre-equilibrated at 37° C. to a final α-thrombin concentration of 7.5 nM. The extent of thrombin inhibition was then calculated using a thrombin standard curve generated by measuring the plasma clotting time versus thrombin concentration, at various thrombin concentrations in the absence of the high affinity binding DNA sequences.

DNA sequences used in the “in-solution” example of HTSA are listed below. All sequences are listed in 5′ to 3′ direction and m=15. Note that adapter complementary sequences possessed overhangs into the constant stem and tail regions of the library from each direction, thus their longer lengths. The forward PCR primer also introduced a 5′ overhang sequence thus its longer length. The overhang sequence was complementary to a sequence planted on the Illumina flowcell and thus facilitated the annealing of the amplified library to the flowcell for sequencing. The sequencing primer was essentially adapter 1.

DNA Sequences:

Structured DNA library
(SEQ ID NO. 1)
ACACGCGCATGCmGCATGCGCCACA
Adapter 1
(SEQ ID NO. 2)
ACACTCTTTCCCTACACGACGCTCTTCCGATCT
Adapter 1 complement
(SEQ ID NO. 3)
GCATGCGCGTGTAGATCGGAAGAGCGTCGTGTAGGGAAAGAGTGT
Adapter 2
(SEQ ID NO.4)
GATCGGAAGAGCTCGTATGCCGTCTTCTGCTTG
Adapter 2 complement
(SEQ ID NO. 5)
CAAGCAGAAGACGGCATACGAGCTCTTCCGATCTGTGGCGCATGC
PCR forward primer
(SEQ ID NO. 6)
AATGATACGGCGACCACCGAGATCTACACTCTTTCCCTACACGACGCTCT
TCCGATCT
PCR reverse primer
(SEQ ID NO. 7)
CAAGCAGAAGACGGCATACGAGCTCTTCCGATCT
Sequencing primer
(SEQ ID NO. 8)
ACACTCTTTCCCTACACGACGCTCTTCCGATCT

### EXAMPLE 2

### Use of Multiplexed Microarray Chips to Discover High Affinity Aptamers Against HIV-1 Nucleocapsid Protein (NCp7)

The process of discovering tight binding sequences was greatly accelerated by systematically searching through a structurally defined library of sequences assembled in microarray format in this example. For this study we successfully screened HIV-1 Nucleocapsid Protein p7 (NC) against a DNA hairpin library containing all possible 3 to 6 nucleotide loop sequences at varying levels of feature complexity. In two consecutive chip screens, we discovered several high affinity DNA loop sequences that bound NC with low nM affinity, as determined by NC-Tryptophan titration assays.

Materials and Methods

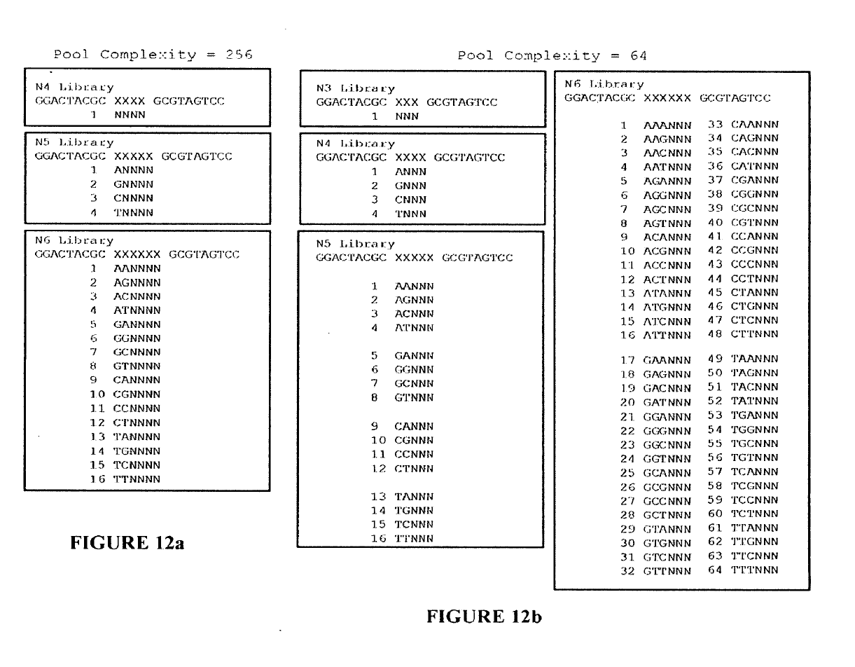

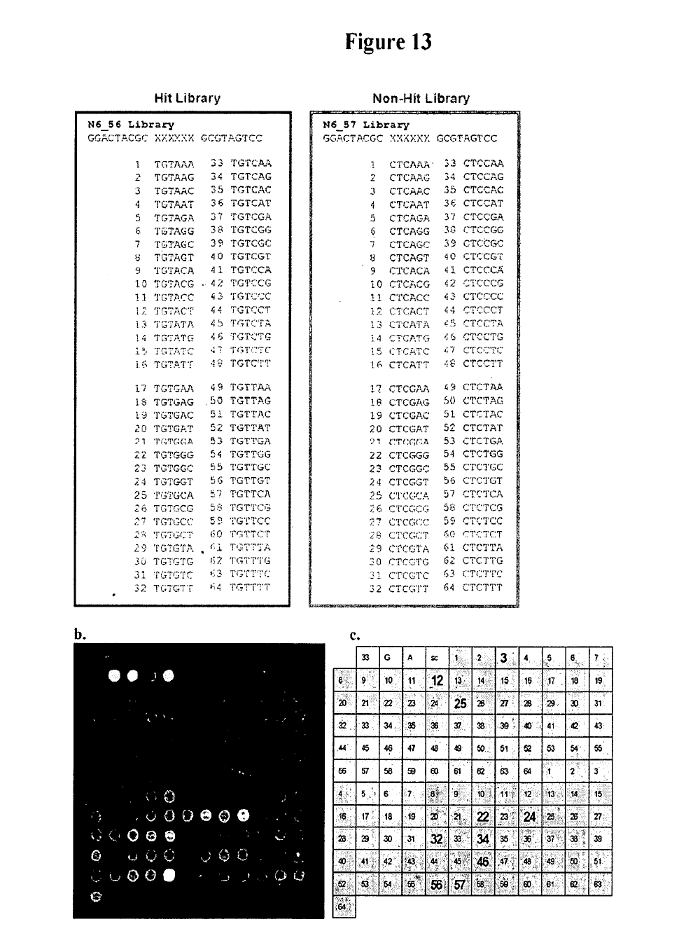

DNA libraries: The N3-N6 DNA hairpin library covered all possible 3 to 6 base loop sequences (21 mers to 24 mers respectively) for a total of 5440 unique sequences. The library was synthesized in pool complexities (# sequences per pool) of 64 (FIG. 12a ) and 256 (FIG. 12b), by including a tract of 3 (NNN) or 4 (NNNN) degenerate DNA base positions respectively. The “enumerated” DNA hairpin libraries used in subsequent chip screens are shown in FIG. 13a. DNA hairpin libraries were ordered from IDT (Integrated DNA Technologies, Inc.) having a 3′ terminal biotin and standard desalting. DNA libraries arrived as normalized 100 uM stocks in 96 well plate format.

Microarray Printing: The DNA libraries were transferred to 384-well plates and diluted 1:1 with 2× spotting buffer (Arrayit, Inc.) making 50 uM printing stocks. DNA libraries were printed using an Omnigrid 100 arrayer, equipped with four state-of-the-art 100 micron silicon wafer printing pins. The libraries were printed on super streptavidin slides (Arrayit, Inc.) in lots of 25 slides, at 70% humidity. Slides were left overnight to dry and subsequently stored in a 4° C. desiccator. Libraries were printed as 4 identical arrays (A, B, C, D) each having 4 identical library “blocks” (1, 2, 3, 4). Control sequences G (positive), 5′GGACUAGCGGUGGCUAGUCC, and A (negative), 5′GGACUAGCGAUAGCUAGUCC have known affinities to NCp7.

Protein Labeling: The HIV-1 NCp7 protein was supplied by Dr. Borer's laboratory (Syracuse University, Chemistry). Fresh stocks of NCp7 protein are routinely made in the laboratory on a weekly basis to >95% homogeneity and in high yield, as determined by SDS-PAGE. Prior to screening, each protein was fluorescently tagged using amino reactive Dylight 549 or 649 reagent (Pierce Biotechnology). Labeling reactions were optimized to obtain 1 label per protein using manufacturer protocols. Unreacted label was completely removed using an affinity purification resin supplied by Pierce Technology.

Protein Screening: Slides were fitted with a 4-well gasket and loaded onto the Fast frame (FIG. 13). To reduce background binding the microarrays were blocked for 1 hour at 25° C. using super streptavidin blocking buffer (Arrayit). The blocking buffer contains a proprietary mix of standard detergent and milk proteins. After blocking, the slides were washed twice with screening buffer (50 mM PBS, Tween (0.1%), 5 mM MgCl₂). This buffer composition was reported by Ellington and coworkers to be a reasonable “universal” buffer for aptamer microarrays screens. Protein samples (100-500 nM, 150 ul) were then transferred to each well, sealed and gently agitated for 30 minute. The slides were washed twice with screening buffer, dried in a slide centrifuge and scanned using an Axon 4100A slide scanner equipped with a Cy3 and Cy5 filter set. Slide images were acquired and analyzed using Genepix 5 (Molecular Dynamics). Data was exported to Excel for further analysis.

NC-Trp Titration assay: The oligonucleotides were independently titrated against NCp7 protein in the microarray screening buffer (PBS, pH 7.4, 0.1% Tween-20, 5 mM MgCl2) at 25° C. The Trp fluorescence at 350 nm was monitored upon addition of concentrated aliquots of oligonucleotide to a 0.35 uM NCp7 sample. Titrations were run on a PTI spectrometer (QM-4/2005 SE, Photon Technology International, Birmingham, N.J.) and data was acquired 5 minutes after each oligonucleotide aliquot using Felix 5.1 software. Data was exported to Excel and K_{d} values determined for each oligonucleotide by fitting titration curves assuming a 1:1 binding model using a nonlinear regression analysis.

Results:

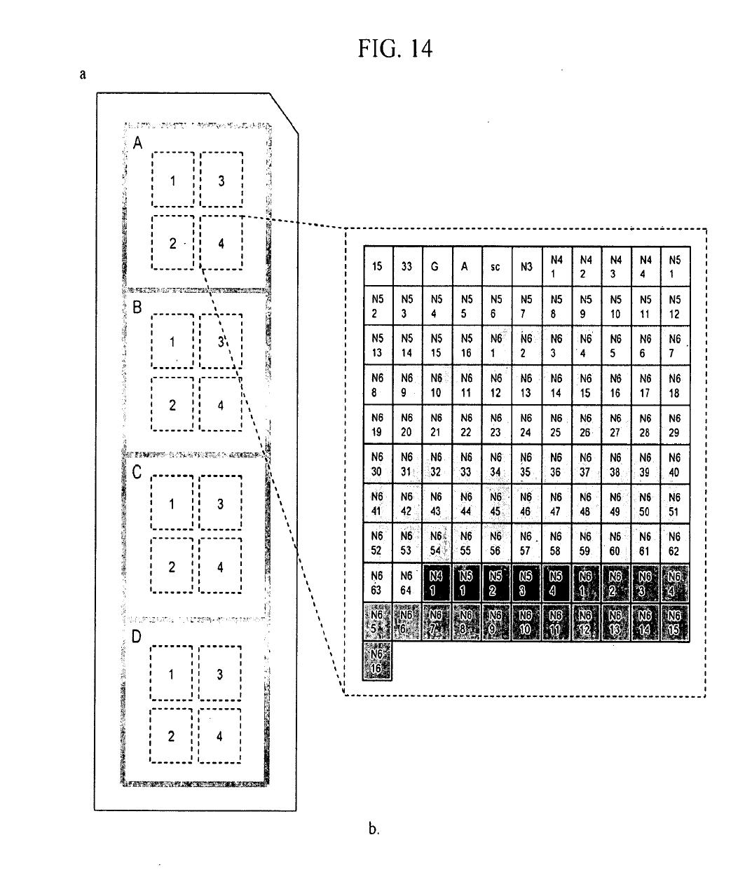

The microarray studies were conducted on Streptavidin chips using biotiylated DNA libraries. The microarray layout is shown in FIG. 14a. To maximize our slide “real estate” 4 identical arrays (A, B, C, D) were printed, each having 4 identical library “blocks” (1, 2, 3, 4). Using a modified Fast® frame assembly (Whatman) four separate samples could be processed on a single slide. The printed array layout of a single “block” is expanded in FIG. 14a. Control sequences or aptamers having known affinities to NCp7 were printed in each “block” to ensure the protein's viability during hybridization. To ensure uniform printing and spot concentrations, one slide of the 25 slide lot, was stained with SYBR 555 DNA stain (Invitrogen), shown in FIG. 14b. The SYBR 555 counts were uniform for the library features; however they were reduced for the NCp7 control features G and A given their shorter sequences and brighter for control features 15 and 33 due to their more complex secondary structure which presumably facilitated a higher SYBR 555 staining capacity.

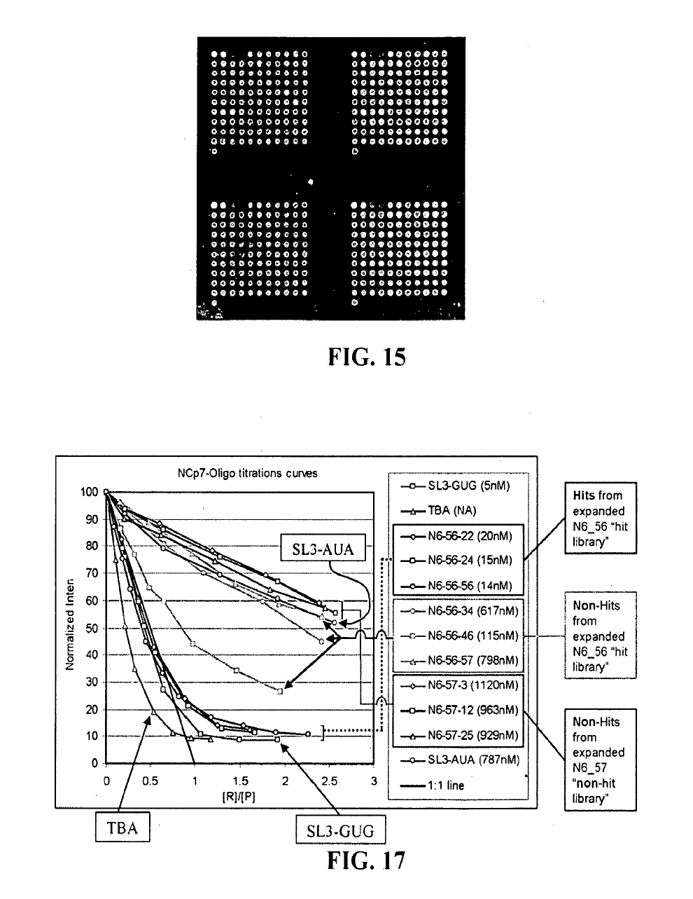

Initial studies were conducted on the N3-N6 diversity chip sets containing features having up to 256 sequences, which were hybridized with Cy3 labeled NC (Cy3-NC). These screens produced a number of hits shown in FIG. 15a. This chip intensity profile was highly reproducible in replicate screens and “hit” features were consistently present over a range of NCp7 concentrations (10 nm-1 uM). NCp7 (NC) also bound appropriately to its RNA control features, strongly to feature G (Kd=10 nM) and weakly to A (Kd=200 nM). In addition, NC also appropriately bound control features 15, 33 and sc, each of which contains rich GTG sequence tracts and have the ability to bind multiple NC proteins, producing what appears to be a very high affinity interaction. This multiple binding is evident from the results of an NC tryptophan titration experiment discussed in the next section. This particular result highlights the importance of characterizing high intensity features, given that a sequence having a single high affinity site or multiple low affinity sites could have similar intensities. This is an important aspect of our multiplexed feature chips and will be discussed in more detail.

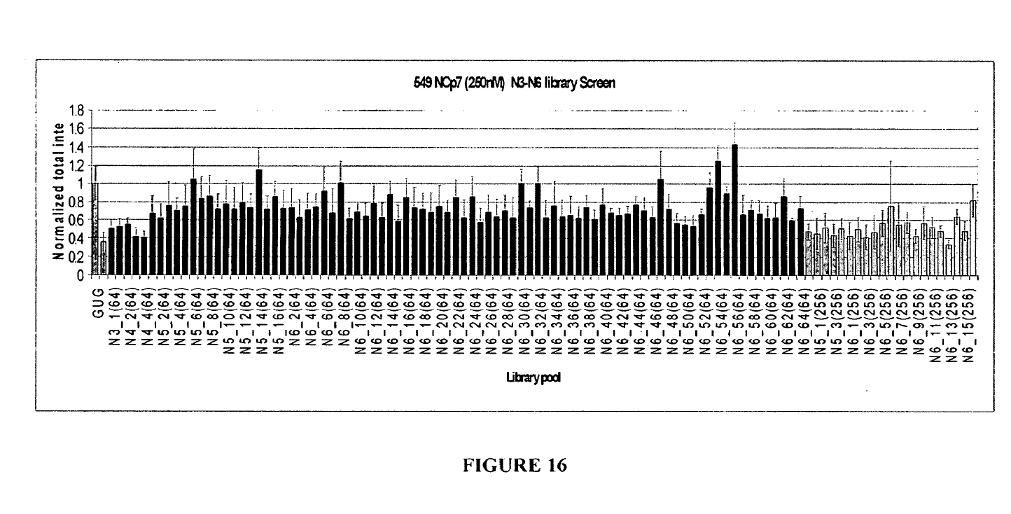

A histogram of the Cy3-NC chip profile is shown in FIG. 16. We observed several features that have average intensities equal to or above the NC positive control G (shown as GUG in histogram). Since the N3-N6 DNA library completely spans several hairpin loop sizes, we can asses both the relative affinities of each sequence pool within each loop and between loops of different sizes. For these studies, we only pursued the highest intensity feature with the goal of further expanding it to discover at least one high affinity sequence. N6_{—}56(64), TGTNNN, was consistently found to be the highest intensity library hit on the chip and within the 64 complexity library features, having an intensity about 1.5 times control GUG and 3.5 times background (AUA), followed closely by feature N6_{—}54(64), TGGNNN.

Collectively, the average intensities of all 64-complexity library features (middle group of darker bars) are higher than the 256-complexity features (right group of lighter bars) for the same library. This is due to the lower concentration of each sequence in a 256-complexity feature, which is ¼ of that same sequence present in a 64-complexity feature. Although the 256-complexity features are less than twice background (AUA), their relative intensities clearly reveal features, N6-6(256) and N6-14(256) mentioned previously.

“Expanded” Chips

The N3-N6 diversity chip allowed us to rapidly assess all possible DNA hairpin loops of 3 to 6 bases against NC in a single microarray. In a second round of screening, the N6_{—}56(64) and N6_{—}57(64) library sets were completely enumerated and printed onto streptavidin chips in the same FAST frame format (FIG. 14a). The N6_{—}56(64) expanded set represents 64 sequences from a “hit” feature and the N6_{—}57(64) represents a 64-sequence expanded set of a “non” hit feature, as presented in FIG. 13a. Inclusion of the “non-hit” library set would provide valuable insight as to the authenticity of a “non-hit” feature. Prior to conducting screens, an N3-N6 diversity chip was stained with Syber 555 to ensure uniformity of feature and printed concentration (data not shown).

The slides were blocked, hybridized with Cy3-NC and washed using identical protocols. The result of this screen and the chip layout is shown in FIGS. 13b and 13c, respectively. The positive control feature (33, G, sc) were all positive while the negative control feature (A) appropriately showed no binding. The non-hit sequences were printed in the top half of the array, FIG. 13c. As expected, there were no hit features in the expanded “non-hit” library set (FIG. 13b), confirming the “non-hit” status of the N6_{—}57(64) feature present on the N3-N6 diversity chip (FIG. 15).

The expanded N6_{—}56(64) hit set was printed in the bottom half of the array, shown in FIG. 13c. In this group of features we can clearly see several distinct hits (FIG. 13b). Strong intensity feature N6_{—}56_{—}56 has the loop sequence TGTTGT, and feature N6_{—}56_{—}24, has loop TGTGGG. These features represent the top two hits on the N6-56/57 chip. Collectively all several loops from the expanded N6_{—}56 library are responsible for the high signal for N6_{—}56(64) and N6_{—}14(256) features present on the diversity chip. Furthermore, the N6_{—}56 library hits, appear to cluster in sets of three for features 22-24, 30-32, and 54-56. These clusters represent sequence families TGTGGX, TGTGTX, and TGTTGX respectively, where X represents C, T and G bases. It appears that having an Adenine (A) in the 3′ end of the loop motif disrupts NCp7 binding to the 6 base hairpin loop.

C-probe/NCp7 Secondary Screens

In preliminary work, the affinity of SL3 RNA hairpin constructs, having point mutations in the loop region, were determined for the NCp7 protein by monitoring the protein's tryptophan fluorescence. The tryptophan-37 residue of NCp7 is fluorescent and its emission is quenched upon formation of a complex with a nucleic acid. This behavior permits a quantitative fluorescence titration to be performed in which RNA (or DNA) is added to an NCp7 solution. The resulting data is then analyzed to determine the stoichiometry of the complex, the residual fluorescence level at saturation and the equilibrium dissociation constant, Kd, for 1:1 complexes (19-21). To confirm the intensity profile of the expanded NC chip screens, a collection of hit and non-hit library sequences were independently investigated using the NC-Trp titration assay.

The results of these NC-Trp titrations are shown in FIG. 17. Here, 3 hit (red) and 3 non-hit (green) sequences from the N6_{—}56(64) expanded library and 3 non-hits (dark green) from the N6_{—}57(64) expanded library were screened along with the NCp7 controls G, A and 33 (TBA), all shown in blue. The G (SL3-GUG) and A (SL3-AUA) titrations essentially set the limits by which all 1:1 (c-probe:NCp7) complexes can be compared. Curves that fall far below the 1:1 line, such as TBA (blue Δ), indicates multiple NCp7 binding sites. The hairpin-like structure associated with the 15 mer G and T residues in TBA, would support the presence of multiple NCp7 binding sites. The N6_{—}56 hit sequences, 22, 24, and 56; all follow the high affinity GUG curve. Their calculated Kd values are essentially identical (ranging from 20-14 nM) and bind in a 1:1 stoichiometry. These properties are nearly identical to the RNA GUG control sequence (G), confirming that we have successfully discovered at least 3 high affinity NCp7 DNA sequences from two consecutive microarray screens. Equally important is that both the N6_{—}56(64) and N6-57(64) non-hit sequences, 34, 57, 3, 12, 25 follow the low affinity AUA curve, having Kd values ranging from low uM to high nM (FIG. 17). The low affinity of these sequences correlates with their very low intensity chip features. Even though sequence 46 is included in the N6_{—}56 non-hit collection, its weak intensity on the chip and 115 nm kd characterize it more as a “weak” hit.

In these studies we discovered a novel set of DNA hairpin constructs with low nM affinities to the NCp7 protein using two multiplex library chips of the present invention. Each protein screen took less than 24 hours to complete from labeling the protein to analyzing the protein's chip profile. The FAST frame slide holder allowed us to rapidly process multiple slides in parallel and under different buffer conditions during the 24 hour period. The only “bottleneck” in the entire process was waiting for IDT (Integrated DNA Technologies, Inc.) to deliver the biotinylated multiplex libraries. The results of these screens surpassed our own expectations in terms of sensitivity, reproducibility and speed. Furthermore, these chip studies and resulting profiles serve as a valuable control library in further optimizing the multiplex microarray format of the invention.

The N3-N6 diversity chips used in the 1st round screens covered all possible 3 to 6 base loop DNA sequences (21 mers to 24 mers respectively) for a total of 5440 unique sequences. The 5440 sequences were systematically covered in a 110 feature arrays using 3 or 4 contiguous degenerate positions within a loop structure. This level of degeneracy allowed us to study feature complexities of 64 and 256 on a single chip for hairpin loop sizes of 3-6 bases. NCp7 was selected as the protein target due to its ability to bind known hairpin loop constructs, which were used as control features.

The N3-N6/NCp7 screens generated several hits as shown in FIG. 15. Of these hits, features N6_{—}56(64), TGTNNN and N6_{—}54(64), TGGNNN, were consistently found to be the highest intensity library hit on the chip within the 64 complexity library. Both of these features represent the highest affinity sequence pools for the 6 base hairpin loop set. Interestingly features N5_{—}14(64), TGNNN, and N5_{—}6(64), GGNNN, are the two highest intensity hits within the 5 base hairpin loop set. This trend continues with higher complexity features N6_{—}6(256), TGNNNN, and N6_{—}14(256), GGNNNN, strongly suggesting a trend of affinity.

Here we successfully demonstrated that multiplexed features of 64 and 256 sequences identify the same 6-base loop sequence class TGXXXX or GGXXXX (where X=A, G, T or C). This is a very important first step in developing the multiplex screening approach. In further embodiments, aptamer libraries with feature complexities of 1024 (NNNNN or 45) are constructed. In using libraries of higher feature complexities, background noises due to manual washing should be minimized by, e.g., automating the hybridization and wash steps using available hybridization stations. Amplifying the hit signals should also facilitate analysis of higher complexity libraries.

If the aim of the experiment is discovering only the highest affinity sequences, it will be important to ensure that no high affinity hits are “hidden” within non-hit features. Screening at lower feature complexities (i.e. higher resolution microarrays) will reduce this problem, but at an expense of library coverage. The present invention contemplates chip resolution as a delicate balance, with the desire for broad coverage of sequence space with high resolution. In various embodiments, high density microarray platforms such as Nimblegen (Roche), Geniom (Febit), and Agilent arrays, are employed in addressing this issue.

Within the expanded N6_{—}56(64) library set, several distinct hits were present, which contributed to the total intensity of the parent N6_{—}56 and N6_{—}14(256) feature on the diversity chip. Loop sequences TGTTGT and TGTGGG represent the top two hits on the expanded N6-56/57 chip. In general, sequence families TGTGGX, TGTGTX, and TGTTGX, where X represents C, T and G bases, have been found to collectively contribute to the total intensity of the parent features. This result demonstrates that the sequences within a multiplex feature are collectively binding as a “family” of sequences, which suggests that having a case where only a single high affinity sequence is present in a multiplex feature is unlikely. In other words, the multiplex feature that possesses the highest affinity “star” sequence will have close sequence homologues that will more than likely bind the protein target with a moderate affinity, and contribute to the protein's overall affinity for that mixture. These sequence homologues are very useful for identifying the best sequences to use as aptamer specific for a given target. They are also useful to distinguish aptamers that are least likely to cross-react with known interferences for a target, simply by screening the interferences against these same arrays at moderate to high complexity. Of course, as the feature complexity increases, the homology of the sequences within the feature will become more distant.

The hit and non-hit sequences discovered using the multiplex microarray method were further investigated using the NC-Trp titration assay. An important aspect of this assay is that these experiments were performed in homogenous buffer solution under equilibrium conditions at physiological ionic strength. Reversibility and reproducibility were demonstrated and the data conformed to the expectations in respect to both equilibrium constant and stoichiometry.

In preliminary NC-Trp titration studies using RNA hairpin constructs of the HIV-1 genomic RNA SL3 motif, 24 of the 64 possible SL3 constructs having GNNN loop diversity (43), showed Kd values ranging from 20,000 to 10 nM, a 2000-fold variation in affinity for these three loop positions (22). Interestingly, the stem sequence and length has very little effect on the stability of the complex, even DNA stems decrease affinity only slightly (23), while replacing RNA loop residues with DNA reduces the stability of the complex by ˜10-fold (24). Results from several of these titration studies indicated the highest affinity sequence loop sequence for SL3 RNA is GGUG followed by GGGG (24). The value of the dissociation constant, Kd, for the GGUG case is 10 nM in 0.20 M NaCl buffer, pH 7.4.(19-21) All of the other loop sequences where found to have lower affinity toward NCp7 (24). These results correlate well with the appearance of GTG and GGG DNA base patterns (for loop positions 4, 5, 6) discovered using the multiplex chip screening approach. Furthermore, our high affinity hit sequences also correlate well with the findings of Fisher et. al. which used surface plasmon resonance (SPR) to study NC binding to series of short DNA oligonucleotides. They found that NC bound tightly to d(G) homopolymers, but exhibited much stronger binding to d(TG)n, were n≧5 (25).

Through work performed in this Example, a novel set of DNA hairpin constructs with low nM affinities to the NCp7 protein was discovered using two Combigen library chips. Each protein screen took less that 24 hour to complete from labeling the protein to analyzing the protein's chip profile. Using a chambered slide holder it was possible to rapidly process multiple slides in parallel and under different buffer conditions in a 24 hour period. The only “bottleneck” in the entire process was the 1 week delay for IDT (Integrated DNA Technologies, Inc.) to synthesize and deliver the biotinylated multiplex libraries. The results of these screens surpassed our own expectations in terms of sensitivity, reproducibility and speed.

Any patent, patent application, publication, or other disclosure material identified in the specification is hereby incorporated by reference herein in its entirety. Any material, or portion thereof, that is said to be incorporated by reference herein, but which conflicts with existing definitions, statements, or other disclosure material set forth herein is only incorporated to the extent that no conflict arises between that incorporated material and the present disclosure material.

TABLE 1
Numbers of DNA hairpin loops for a starting pool containing
100 pmol of mixed oligonucleotides.

| m | pₘ | Nₚ | tₘ |
|---|---|---|---|
| 1 | 4 | 1.5E+13 | 2E+06 |
| 2 | 16 | 3.8E+12 | 4E+05 |
| 3 | 64 | 9.4E+11 | 9E+04 |
| 4 | 256 | 2.4E+11 | 2E+04 |
| 5 | 1,024 | 5.9E+10 | 6E+03 |
| 6 | 4,096 | 1.5E+10 | 1E+03 |
| 7 | 16,384 | 3.7E+09 | 4E+02 |
| 8 | 65,536 | 9.2E+08 | 9E+01 |
| 9 | 262,144 | 2.3E+08 | 2E+01 |
| 10 | 1.0E+06 | 5.7E+07 | 6E+00 |
| 11 | 4.2E+06 | 1.4E+07 | 1E+00 |
| 12 | 1.7E+07 | 3.6E+06 | 4E−01 |
| 13 | 6.7E+07 | 9.0E+05 | 9E−02 |
| 14 | 2.7E+08 | 2.2E+05 | 2E−02 |
| 15 | 1.1E+09 | 56,066 | 6E−03 |
| 16 | 4.3E+09 | 14,016 | 1E−03 |
| 17 | 1.7E+10 | 3,504 | 3E−04 |
| 18 | 6.9E+10 | 876 | 9E−05 |
| 19 | 2.7E+11 | 219 | 2E−05 |
| 20 | 1.1E+12 | 55 | 5.5E−06 |
| 21 | 4.4E+12 | 14 | 1.4E−06 |
| 22 | 1.8E+13 | 3.4 | 3.4E−07 |
| 23 | 7.0E+13 | 0.9 | 8.5E−08 |
| 30 | 1.2E+18 | Sparse | 5.2E−12 |
| 50 | 1.3E+30 | Sampling | 4.7E−24 |
| 70 | 1.4E+42 | | 4.3E−36 |
| 120 | 1.8E+72 | | 3.4E−66 |

Calculations made for 100 pmol of library.
AM=6.02E+13 is the total number of all NA molecules in the library.
m=length of varied loop sequence.
pₘ=4^{m}, the number of unique sequences of length, m.
Nₚ=AM/pₘ, the average number of each unique molecule in a pool that includes only length m.
H=6.0E06, the number of readable sequences from a chip.
tₘ=H/pₘ, is the average number of times a given loop in a pool of length, m, should be sequenced in the absence of a prior separation step.

TABLE 2
Folders generated by Perl script

| Folder | Contents description |
|---|---|
| Location Statistics | NNNNNNNNNNNNmNNNNNNNNNNNN |
| | Counts of each of the 4 possible bases in each of the designated positions for |
| | each sequence in the Illumina Genome Analyzer generated text file. These are |
| | compared to the expected sequence to determine sequencing accuracy and PCR |
| | mutation rates |
| Bad reads | NNNNNNNNNNNNmNNNNNNNNNNNN |
| | Sequences that contain > 2 mismatches or > 1 gap within the flanking N strings. |
| | These include contamination DNA or heavily mutated or misread sequences. |
| Candidate reads | NN [symbol] [symbol] [symbol] [symbol] [symbol] [symbol] [symbol] [symbol] [symbol] [symbol] m ≠ 15 [symbol] [symbol] [symbol] [symbol] NNNNNNNN |
| | Sequences that contain ≦ 2 mismatches and < 1 gap in the flanking N string, and |
| | a variable region string of m ≠ 15. This may be due to insertion and deletion |
| | mutations. |
| Good reads | NN [symbol] [symbol] [symbol] [symbol] [symbol] [symbol] [symbol] [symbol] [symbol] [symbol] m = 15 [symbol] [symbol] [symbol] [symbol] NNNNNNNN |
| | Sequences with the correct flanking sequences ( [symbol] string ≦ 2 mismatches and < 1 |
| | gap) and an m = 15 in the variable region |
| Nmer count | Counts the frequency of occurrence for each sequence in the “Good reads” file |
| | and ranks the sequence by count. |

N = DNA base,
N = unsorted sequence from parent sequencing file,
N = incorrect sequence in barcode, [symbol]
= correct constant stem base,
m = library region

TABLE 3
Base calling statistics of the latter 10 bases of the constant stem region to the left of the
degenerate region in the selected library
HEADER SEQUENCE

| | A | C | G | C | G | C | A | T | G | C |
|---|---|---|---|---|---|---|---|---|---|---|
| match | 99.85% | 99.93% | 99.81% | 99.89% | 99.86% | 99.88% | 99.74 | 99.82% | 99.78% | 99.81% |
| mismatch | 0.15% | 0.07% | 0.12% | 0.07% | 0.08% | 0.09% | 0.15% | 0.10% | 0.14% | 0.19% |
| deletion | 0.00% | 0.00% | 0.08% | 0.04% | 0.06% | 0.03% | 0.11% | 0.08% | 0.09% | 0.00% |
| insertion | 0.00% | 0.00% | 0.08% | 0.09% | 0.04% | 0.07% | 0.04% | 0.12% | 0.08% | 0.09% |

Base calling statistics of the first 4 bases of the constant stem region to the right of the
degenerate region in the selected library
FOOTER SEQUENCE

| | G | C | A | T | G |
|---|---|---|---|---|---|
| match | 97.89% | 99.06% | 95.52% | 99.78% | 95.29% |
| mismatch | 2.11% | 0.94% | 4.48% | 0.22% | 4.71% |
| deletion | 0.00% | 0.00% | 0.00% | 0.00% | 0.00% |
| insertion | 0.00% | 0.00% | 0.01% | 0.01% | 0.00% |

TABLE 4
Counting results of aptamer candidates
against α-thrombin.

| Sequence | | |
|---|---|---|
| ranking | m = 15 loop | Count^{a} |
| | Motif I (TBA motif) | |
| 1 | GGTTGGTGTGGTTGG | 46444 |
| 3 | GGTTGGTGTGGTTTG | 2451 |
| 9 | GGTTGGTTTGGTTGG | 419 |
| 25 | GGTTGGTGCGGTTGG | 97 |
| | Motif II | |
| 51 | AGTGTGGTCGGAAGT | 53 |
| 54 | ATGTGGCGAGGATGA | 48 |
| 56 | TATGTGGGTGAATGC | 42 |
| 121 | GTTGGTGGCGGAAGG | 10 |
| | Motif III | |
| 2 | GCTATCATCGCAACG | 29405 |
| 4 | GCTATCATCGCACCG | 1040 |
| 8 | GCTCTCATCGCAACG | 432 |
| 34 | GCTATCATCTCAACG | 80 |

^{a}A total of 4,749,241 reads had validated stems separated by 15 bases, with 4,237,141 unique sequences found. Only 4 sequences with varying count numbers from each conserved sequence group are shown.

### REFERENCES

1. Jayasena, S. D. (1999) Aptamers: an emerging class of molecules that rival antibodies in diagnostics. Clin Chem, 45, 1628-1650.
2. Gold, L. (1995) Oligonucleotides as research, diagnostic, and therapeutic agents. J Biol Chem, 270, 13581-13584.
3. Tuerk, C. and Gold, L. (1990) Systematic evolution of ligands by exponential enrichment: RNA ligands to bacteriophage T4 DNA polymerase. Science, 249, 505-510.
4. Ellington, A. D. and Szostak, J. W. (1990) In vitro selection of RNA molecules that bind specific ligands. Nature, 346, 818-822.
5. Fitzwater, T. and Polisky, B. (1996) A SELEX primer. Methods in enzymology, 267, 275-301.
6. Cox, J. C., Rajendran, M., Riedel, T., Davidson, E. A., Sooter, L. J., Bayer, T. S., Schmitz-Brown, M. and Ellington, A. D. (2002) Automated acquisition of aptamer sequences. Comb Chem High Throughput Screen, 5, 289-299.
7. Choi, Y. S., Pack, S. P. and Yoo, Y. J. (2005) Development of a protein microarray using sequence-specific DNA binding domain on DNA chip surface. Biochemical and biophysical research communications, 329, 1315-1319.
8. Wang, J., Bai, Y., Li, T. and Lu, Z. (2003) DNA microarrays with unimolecular hairpin double-stranded DNA probes: fabrication and exploration of sequence-specific DNA/protein interactions. Journal of biochemical and biophysical methods, 55, 215-232.
9. Mukherjee, S., Berger, M. F., Jona, G., Wang, X. S., Muzzey, D., Snyder, M., Young, R. A. and Bulyk, M. L. (2004) Rapid analysis of the DNA-binding specificities of transcription factors with DNA microarrays. Nature genetics, 36, 1331-1339.
10. Berger, M. F., Philippakis, A. A., Qureshi, A. M., He, F. S., Estep, P. W., 3rd and Bulyk, M. L. (2006) Compact, universal DNA microarrays to comprehensively determine transcription-factor binding site specificities. Nature biotechnology, 24, 1429-1435.
11. Bulyk, M. L. (2006) Analysis of sequence specificities of DNA-binding proteins with protein binding microarrays. Methods in enzymology, 410, 279-299.
12. Bulyk, M. L. (2006) DNA microarray technologies for measuring protein-DNA interactions. Current opinion in biotechnology, 17, 422-430.
13. Bulyk, M. L. (2007) Protein binding microarrays for the characterization of DNA-protein interactions. Advances in biochemical engineering/biotechnology, 104, 65-85.
14. Bulyk, M. L., Gentalen, E., Lockhart, D. J. and Church, G. M. (1999) Quantifying DNA-protein interactions by double-stranded DNA arrays. Nature biotechnology, 17, 573-577.
15. Warren, C. L., Kratochvil, N. C., Hauschild, K. E., Foister, S., Brezinski, M. L., Dervan, P. B., Phillips, G. N., Jr. and Ansari, A. Z. (2006) Defining the sequence-recognition profile of DNA-binding molecules. Proceedings of the National Academy of Sciences of the United States of America, 103, 867-872.
16. Li, Y., Lee. H. J. and Corn, R. M. (2006) Fabrication and characterization of RNA aptamer microarrays for the study of protein-aptamer interactions with SPR imaging. Nucleic acids research, 34, 6416-6424.
17. Collett, J. R., Cho, E. J. and Ellington, A. D. (2005) Production and processing of aptamer microarrays. Methods (San Diego, Calif., 37, 4-15.
18. Collett, J. R., Cho, E. J., Lee, J. F., Levy, M., Hood, A. J., Wan, C. and Ellington, A. D. (2005) Functional RNA microarrays for high-throughput screening of antiprotein aptamers. Analytical biochemistry, 338, 113-123.
19. Paoletti, A. C. (2004) Ph.D. dissertation, Syracuse University.
20. Paoletti, A. C., Shubsda, M. F., Hudson, B. S. and Borer, P. N. (2002) Affinities of the Nucleocapsid Protein for Variants of SL3 RNA in HIV-1. Biochemistry, 41, 15423-15428.
21. Shubsda, M. F., Paoletti, A. C., Hudson, B. S. and Borer, P. N. (2002) Affinities of Packaging Domain Loops in HIV-1 RNA for the Nucleocapsid Protein. Biochemistry, 41, 5276-5282.
22. Paoletti, A. C., Shubsda, M. F., Hudson, B. S. and Borer, P. N. (2002) Affinities of the nucleocapsid protein for variants of SL3 RNA in HIV-1. Biochemistry, 41, 15423-15428.
23. Paoletti, A. C. (2004) Ph.D. Dissertation, Syracuse University, Syracuse, N.Y. 13244.
24. Shubsda, M. F., Paoletti, A. C., Hudson, B. S. and Borer, P. N. (2002) Affinities of packaging domain loops in HIV-1 RNA for the nucleocapsid protein. Biochemistry, 41, 5276-5282.
25. Fisher, R. J., Rein, A., Fivash, M., Urbaneja, M. A., Casas-Finet, J. R., Medaglia, M. and Henderson, L. E. (1998) Sequence-specific binding of human immunodeficiency virus type 1 nucleocapsid protein to short oligonucleotides. Journal of virology, 72, 1902-1909.
26. Bock, L. C., Griffin, L. C., Latham, J. A., Vermaas, E. H. and Toole, J. J. (1992) Selection of single-stranded DNA molecules that bind and inhibit human thrombin. Nature, 355, 564-566.
27. Rusconi, C. P., Scardino, E., Layzer, J., Pitoc, G. A., Ortel, T. L., Monroe, D. and Sullenger, B. A. (2002) RNA aptamers as reversible antagonists of coagulation factor IXa. Nature, 419, 90-94.

1. An aptamer library comprising a plurality of aptamer candidates, each of said aptamer candidates of substantially the same length and having a primary structure and a pre-selected secondary structure, said primary structure comprising at least a variable nucleotide sequence where nucleotides at m number of positions are being varied, said secondary structure comprising at least a single-stranded region and a double-stranded region, wherein said variable sequence is at least part of said single-stranded region, and
wherein for every 100 pmol of said aptamer candidates, an average of at least about three copies of each possible variable sequence is represented.

2. The aptamer library of claim 1, wherein for every 100 pmol of said aptamer candidates, an average of at least about six copies of each possible variable sequence is represented.

3. The aptamer library of claim 1, wherein m is at least about 5.

4. The aptamer library of claim 1, wherein each of said aptamer candidates is about 50-60 nucleotides in length and wherein m is about 25 or less.

5. The aptamer library of claim 1, wherein each of said aptamer candidates has a common secondary structure.

6. The aptamer library of claim 1, wherein each of said aptamer candidates comprises an oligonucleotide selected from the group consisting of DNAs, RNAs, PNA, modified nucleotides, and mixtures of any of the above.

7. The aptamer library of claim 1, wherein said aptamer library comprises at least 10⁹ distinct members.

8. The aptamer library of claim 1, wherein each of said aptamer candidates is no more than 100 nucleotides in length.

9. The aptamer library of claim 1, wherein each of said aptamer candidates is no more than 75 nucleotides in length.

10. The aptamer library of claim 1, wherein each of said aptamer candidates is no more than 50 nucleotides in length.

11. The aptamer library of claim 1, wherein said aptamer library comprises a plurality of concatenated aptamers.

12. The aptamer library of claim 11, wherein said concatenated aptamers comprise two or more identical secondary structures.

13. The aptamer library of claim 11, wherein said concatenated aptamers comprise two or more non-identical secondary structures.

14. The aptamer library of claim 11, wherein said concatenated aptamers comprise a combination of identical and non-identical secondary structures.

15. The aptamer library of claim 1, wherein said pre-selected secondary structure comprises a hairpin loop, a bulge loop, an internal loop, a multi-branch loop, a pseudoknot or combinations thereof.

16. The aptamer library of claim 1, wherein said variable sequence has randomized nucleotides at some positions and invariant nucleotides at other positions.

17. The aptamer library of claim 1, wherein said variable sequence comprises randomized nucleotides at all positions.

18. The aptamer library of claim 1, wherein said variable sequence is completely within said single-stranded region.

19. The aptamer library of claim 1, wherein said variable sequence comprises nucleotides at positions in said double-stranded region that are no more than three nucleotides away from an end of said single-stranded region.

20. A microarray chip, comprising the aptamer library of claim 1.

21-130. (canceled)
